(19) United States
(12) Patent Application Publication
(10) Pub. No.: US 2025/0158564 A1
(43) Pub. Date: May 15, 2025

(54) SOLAR ENERGY APPARATUS FOR MODULAR BUILDINGS

(71) Applicant: WILLIAMS SCOTSMAN, INC., Baltimore, MD (US)

(72) Inventors: Nyssa Hughes, Towson, MD (US); Corey Salemi, Baltimore, MD (US); Gregg Sheddy, Shrewsbury, PA (US); Reza Shirani, Toronto (CA); Kevin Walsh, Parker, TX (US); Robert Cox, Tampa, FL (US); Danya Cota Ruiz, Phoenix, AZ (US); Justin Cooper, Baltimore, MD (US); Thierry LeBoul’ch, Irving, TX (US); Rick Owen, New York, NY (US)

(73) Assignee: WILLIAMS SCOTSMAN, INC., Baltimore, MD (US)

(21) Appl. No.: 18/942,234

(22) Filed: Nov. 8, 2024

Related U.S. Application Data
(60) Provisional application No. 63/597,588, filed on Nov. 9, 2023.
(60) Provisional application No. 63/622,005, filed on Jan. 17, 2024.

(51) Int. Cl. H02S 30/20; H02S 20/23; H02S 30/10; H02S 40/34

(52) U.S. Cl. CPC H02S 30/20; H02S 20/23; H02S 30/10; H02S 40/34

(57) ABSTRACT

A solar apparatus for use with a mobile building includes an enclosure and an array comprised of photovoltaic panels. A convexity of the array along a longitudinal direction of the solar apparatus defines an open space under the panel. The enclosure can be positioned in the open space.

### CROSS-REFERENCE TO RELATED PATENT APPLICATIONS

This application claims the benefit of and priority to U.S. Provisional Application No. 63/597,588 filed Nov. 9, 2023 and U.S. Provisional Application No. 63/622,005 filed Jan. 17, 2024, their entire disclosure of which is incorporated by reference herein.

### BACKGROUND

The present disclosure relates generally to modular buildings, for example mobile buildings and other mobile structures. Some such modular buildings are formed from storage or shipping containers and/or otherwise constructed with standardized shipping container dimensions. Such modular buildings are often deployed in environments (e.g., construction sites, mining sites, oil rigs) where electricity from a power grid is not readily available. An easily deployable, alternative or supplemental source of electricity for such modular buildings would be desirable.

### SUMMARY

Embodiments of the present disclosure include a solar apparatus for use with a mobile building. The solar apparatus includes an enclosure and an array of photovoltaic panels. A convexity of the array along a longitudinal direction of the solar apparatus defines an open space under the array, and the enclosure is positioned in the open space.

In some embodiments, the solar apparatus also includes a base frame member extending along the longitudinal direction of the solar apparatus. The base frame member is substantially straight and the open space is between the base frame member and the array of photovoltaic panels. The convexity of the panel may be such that the longitudinal ends of the panel are closer to the base frame member than a longitudinal center of the array. The enclosure can be positioned at the longitudinal center of the panel. The enclosure may be configured to slide from a stowed position in the open space under the array to an access position laterally extending from the array. The base member may comprise a first beam and a second beam, each defining a channel and spaced for receiving forks of a standardized forklift. The enclosure may include one or more inlet plugs to provide power to the solar apparatus and one or more outlet plugs to enable access to power generated by and/or stored by the solar apparatus. The solar apparatus may also include a lateral base frame member extending along a lateral direction of the solar apparatus, a first junction box extending along the lateral base frame member, a second junction box extending along the lateral base frame member, and a second enclosure positioned in the open space. The array may be coupled to a flexible fabric. The solar apparatus may also include a cable management frame. The cable management frame may include a vertical portion, a longitudinal portion extending along the longitudinal direction of the solar apparatus, the longitudinal portion centered on the vertical portion, a plurality of hooks extending from the longitudinal portion, and a plurality of bumpers extending from the longitudinal portion.

In some embodiments, the solar apparatus includes a battery energy storage component positioned in the enclosure and control components and electronics. The control components and electronics are configured to manage energy from the photovoltaic panels or other energy source and to manage charging and discharging of the battery energy storage components.

In some embodiments, the array includes a flexible panel and a flexible backing sheet coupled to the panel. The solar apparatus can include a curved frame including a beam, wherein the beam includes a groove. An edge of the backing sheet can be received in the groove.

In some embodiments, the solar apparatus also includes an additional array moveable relative to the array. The additional array has a curvature substantially matching the convexity of the array. The solar apparatus may also include a cable management system configured to maintain, throughout a range of motion of the additional array, a constant distance for a path of travel for a cable extending between the additional array and the enclosure. The cable management system may include a first arm coupled in series with a second arm, where the first arm has a first end at a fixed point on a frame of the array and the second arm has a second end at fixed point on the additional array. The cable management system can also include a track and a trolley slidable along the track, with a joint between the first arm and the second arm positioned at the trolley.

In some embodiments, the solar apparatus also includes corner posts. In some embodiments, the solar apparatus includes a clamp configured to laterally span a roof of a mobile building and connectors coupling the corner posts to the clamp. The solar apparatus can also include support legs coupled to the clamp and extending along a height of the mobile building. In some embodiments, a height of the corner posts is greater than a height of the array, for example such that the corner posts can facilitate stacking of the solar apparatus on or under an additional solar apparatus.

In some embodiments, a solar assembly includes a solar assembly. The solar assembly includes a first solar apparatus, a second solar apparatus, and a cradle. The first solar apparatus includes a first enclosure, a first array of photovoltaic panels, and a first base frame member. A convexity of the first array along a longitudinal direction of the first solar apparatus defines an open space under the first array, wherein the first enclosure is positioned in the open space. The first base frame member extends along the longitudinal direction of the first solar apparatus. The second solar apparatus includes a second enclosure, a second array of photovoltaic panels, and a second base frame member. The cradle extends along the longitudinal direction of the first solar apparatus. The cradle is configured to receive the first base frame member and the second base frame member and couple to the mobile building.

In some embodiments, a solar assembly includes a first solar apparatus for use with a first mobile building and a second solar apparatus for use with a second mobile building. The first solar apparatus includes an enclosure and an array of photovoltaic panels. A convexity of the array along a longitudinal direction of the first solar apparatus defines an open space under the array, wherein the enclosure is positioned in the open space. The first solar apparatus is configured to electrically couple to the second solar apparatus.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a first perspective view of a solar apparatus deployed on a mobile structure, according to some embodiments.

FIG. 2 is a second perspective view of the solar apparatus deployed on the mobile structure, according to some embodiments.

FIG. 3 is an end view of the solar apparatus deployed on the mobile structure, according to some embodiments.

FIG. 4 is a side view of the solar apparatus deployed on the mobile structure, according to some embodiments.

FIG. 5A is a first perspective view of the solar apparatus, according to some embodiments.

FIG. 5B is a second perspective view of the solar apparatus, according to some embodiments.

FIG. 5C is a top view of the solar apparatus, according to some embodiments.

FIG. 6 is a diagram of a cable management system of the solar apparatus, according to some embodiments.

FIG. 7 is storyboard-style illustration of operation of enclosures of a solar apparatus, according to some embodiments.

FIG. 8 is a perspective, cut-away view of enclosures of the solar apparatus, according to some embodiments.

FIG. 9 is a top view of the enclosures of FIG. 8, according to some embodiments.

FIG. 10 is a first perspective view of an enclosure for a solar apparatus, according to some embodiments.

FIG. 11 is a second perspective view of an enclosure for a solar apparatus, according to some embodiments.

FIG. 12 is an illustration of a handheld controller in use with an enclosure for a solar apparatus, according to some embodiments.

FIG. 13 is an exploded view of a photovoltaic (PV) panel assembly for a solar apparatus, according to some embodiments.

FIG. 14 is a first illustration of coupling of the PV panel assembly to a frame of a solar apparatus, according to some embodiments.

FIG. 15 is a second illustration of coupling the PV panel assembly to a frame of a solar apparatus, according to some embodiments.

FIG. 16 is a third illustration of coupling the PV panel assembly to a frame of a solar apparatus, according to some embodiments.

FIG. 17 is an illustration of a mounting structure for a solar apparatus, according to some embodiments.

FIG. 18 is another illustration of a mounting structure for a solar apparatus, according to some embodiments.

FIG. 19 is another illustration of a mounting structure for a solar apparatus, according to some embodiments.

FIG. 20 is another illustration of a mounting structure for a solar apparatus, according to some embodiments.

FIG. 21 is a first perspective view of a PV panel assembly for a solar apparatus, according to some embodiments.

FIG. 22 is a second perspective view of the PV panel assembly of FIG. 21, according to some embodiments.

FIG. 23 is an end view of the PV panel assembly, according to some embodiments.

FIG. 24 is an illustration of coupling of panel assemblies to a frame of a solar apparatus, according to some embodiments.

FIG. 25 is a perspective view of a solar apparatus, according to some embodiments.

FIG. 26 is a top view of a solar apparatus, according to some embodiments.

FIG. 27 is a side view of a solar apparatus, according to some embodiments.

FIG. 28 is a side view of an end portion of a solar apparatus, according to some embodiments.

FIG. 29 is a top view of a base frame of a solar apparatus, according to some embodiments.

FIG. 30 is a side view of a base frame of a solar apparatus, according to some embodiments.

FIG. 31 is a top view of a solar array, according to some embodiments.

FIG. 32 is a side view of a solar array, according to some embodiments.

FIG. 33 is a close-up view of an end portion of a solar array, according to some embodiments.

FIG. 34 is an illustration of a system including multiple solar apparatuses, according to some embodiments.

FIG. 35 is another view of a solar apparatus, according to some embodiments.

FIG. 36 is another view of a solar apparatus, according to some embodiments.

FIG. 37 is another view of a solar apparatus, according to some embodiments.

FIG. 38 is view of an enclosure of a solar apparatus, according to some embodiments.

FIG. 39 is another view of an enclosure of a solar apparatus, according to some embodiments.

FIG. 40 is an illustration of use of an enclosure of a solar apparatus, according to some embodiments.

FIG. 41 is yet another view of an enclosure of a solar apparatus, according to some embodiments.

FIG. 42 is another view of an enclosure of a solar apparatus, according to some embodiments.

FIG. 43 is a view of electronics of an enclosure of a solar apparatus, according to some embodiments.

FIG. 44 is perspective view of a solar apparatus, according to some embodiments.

FIG. 45 is an end view the solar apparatus, according to some embodiments.

FIG. 46 is another end view of the solar apparatus, according to some embodiments.

FIG. 47 is a side view of a junction box of the solar apparatus, according to some embodiments.

FIG. 48 is another side view of a junction box of the solar apparatus, according to some embodiments.

FIG. 49 is a side view of the solar apparatus, according to some embodiments.

FIG. 50 is a block diagram of a solar assembly including the solar apparatus, according to some embodiments.

FIG. 51 is a perspective view of a portion the solar apparatus, according to some embodiments.

FIG. 52 is a perspective view of a cable management frame of the solar apparatus, according to some embodiments.

FIG. 53 is a side view of an enclosure of the solar apparatus, according to some embodiments.

FIG. 54 is a top view of a portion of the solar apparatus, according to some embodiments.

FIG. 55 is a cross-sectional view of the solar apparatus, according to some embodiments.

FIG. 56 is a perspective view of a drawer mechanism of the solar apparatus, according to some embodiments.

FIG. 57 is a side view of the drawer mechanism of the solar apparatus, according to some embodiments.

FIG. 58 is a block diagram of a solar assembly including a plurality solar apparatuses, according to some embodiments.

FIG. 59 is a perspective view of a solar apparatus deployed on a mobile structure, according to some embodiments.

FIG. 60 is a perceptive view of a cradle of the solar apparatus, according to some embodiments.

FIG. 61 is a perspective view of a solar apparatus including a canopy, according to some embodiments.

FIG. 62 is a perspective view of a solar apparatus deployed on a mobile structure, according to some embodiments.

FIG. 63 is a perspective view of a frame and solar canopy of the solar apparatus, according to some embodiments.

FIG. 64 is a perspective view of a solar apparatus deployed on a mobile structure, according to some embodiments.

FIG. 65 is a perspective view of a frame and solar canopy of the solar apparatus, according to some embodiments.

FIG. 66 is a perspective view of a frame of a solar apparatus, according to some embodiments.

FIG. 67 is a perspective view of a solar canopy, according to some embodiments.

FIG. 68 is a perspective view of a solar canopy, according to some embodiments.

### DETAILED DESCRIPTION

Referring generally to the figures, a solar apparatus for modular buildings or other mobile structures (e.g., storage containers, shipping containers) is shown, according to various embodiments. The teachings herein provide for a solar apparatus which can be easily installed on mobile structure and which includes photovoltaic (PV) panels (sometimes referred to as solar panels) configured to convert solar irradiation into electrical energy and onboard electronics (e.g., power electronics, inverter, batteries or other energy storage, etc.) for handling of the electrical energy generated by the PV panels. The PV panels and onboard electronics can be provided together according to the teachings herein in a modular solar apparatus which can then be easily deployed in the field without need for wiring and other configuration and installation of such electronics in the field. Various structural characteristics of the solar apparatuses described herein further enable easy deployment, as will be described in further detail below.

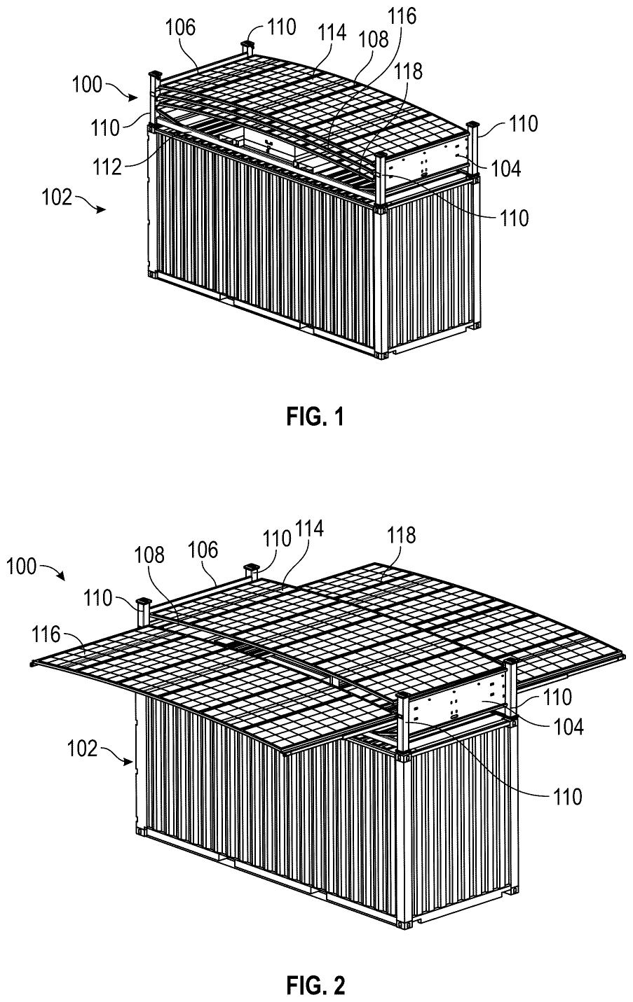

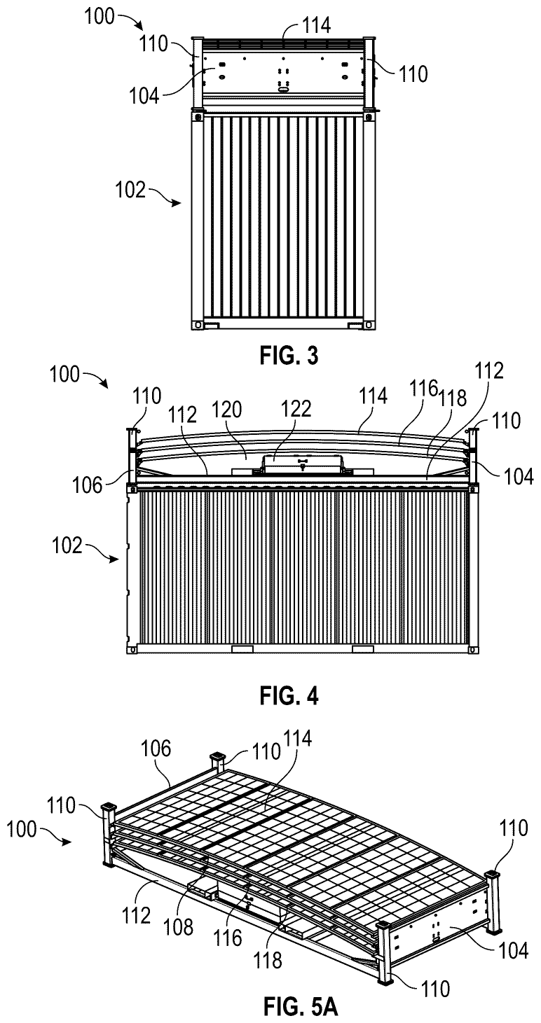

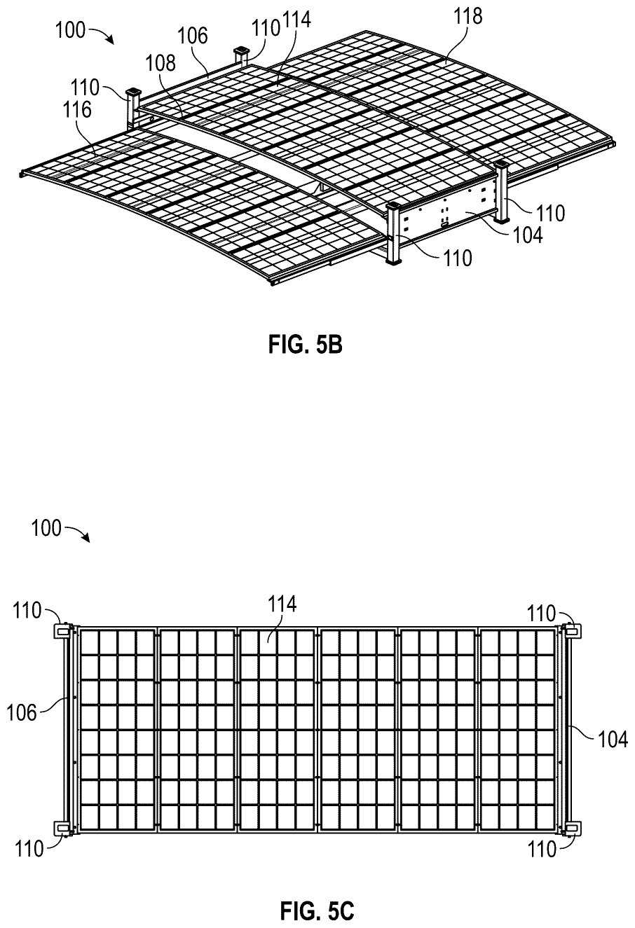

Referring now to FIGS. 1-5C, views of a solar apparatus 100 are shown, according to some embodiments. FIGS. 1-4 show the solar apparatus 100 deployed on a mobile structure 102, with FIGS. 5A-C showing the solar apparatus 100 without the mobile structure 102.

As shown, the mobile structure 102 is a shipping container. In some embodiments, the mobile structure 102 is a mobile and/or modular building, for example a structure having substantially similar dimensions as a standard shipping container and configured as an office or type of space for occupation by people, equipment, etc. The mobile structure 102 can be sized so as to be suitable for transportation using standard transportation network equipment and infrastructure (e.g., trucks, roadways, trains, railways, etc.).

The solar apparatus 100 is shown as being positioned on a top (roof) of the mobile structure 102. The solar apparatus 100 includes a first end 104, a second end 106 opposite the first end 104, and a curved frame 108 extending from the first end 104 to the second end 106. The first end 104 and the second end 106 are shown as being substantially the same width as the longitudinal ends of the mobile structure 102, while the curved frame 108 is shown has having substantially the same length as the mobile structure 102, such that the length and width of the solar apparatus 100 substantially matches the length and width of the mobile structure 102. For example, the first end 104, the second end 106, and the curved frame 108 may have dimensions consistent with the length and width of a standard shipping container (e.g., as defined by the International Organization for Standardization). The solar apparatus 100 also includes posts 110 positioned at corners thereof, i.e., at lateral ends of the first end 104 and the second end 106, which are aligned with corners of the mobile structure 102. The solar apparatus 100 is also shown as including at least one base frame member 112 extending between the first end 104 and the second end 106 and configured to provide structural support for the solar apparatus 100.

The solar apparatus 100 is also shown as including a first array 114 of photovoltaic (PV) cells positioned along and fixed in position relative to the curved frame 108, a second array 116 of PV cells moveable relative to the curved frame 108, and a third array 118 of PV cells moveable relative to the curved frame 108. FIGS. 1, 3, 4 and 5A show the second array 116 and the third array 118 in retracted (stowed, out-of-use) positions under the first array 114, while FIG. 2 shows the second array 116 and the third array 118 in deployed (extended, in-use) positions with the second array 116 positions on a first side of the first array 114 and the third array 118 positioned on an opposite side of the first array 114. With the second array 116 and the third array 118 are in the retracted positions (as in FIG. 1), little or no solar energy will be incident on the PV cells thereof. With the second array 116 and the third array 118 in the deployed positions, solar energy will be incident on the first array 114, the second array 116, and the third array 118. Accordingly, in the deployed positions PV cells of the first array 114, the second array 116, and the third array 118 are suitable positioned for collection of solar energy and generation of electricity.

In the embodiments shown, the second array 116 and the third array 118 are provided on tracks, drawer mechanisms, or the like so as to be slidable between the retracted positions and the deployed positions. The second array 116 may be repositionable independent of the third array 118 and vice versa. As shown, the second array 116 and the third array 118 are substantially parallel with one another and with the first array 114 and the curved frame 108. In other embodiments, the first array 114, the second array 116, and/or the third array 118 is configured to tilt to an in-use, deployed position, for example to rotate towards the sun to maximizes direct incidence of solar irradiation. In the embodiments shown, curvature of the first array 114, the second array 116, and the third array 118 may facilitate efficient collection of solar energy at various angles of sun incidence (e.g., as the sun moves throughout the day), for example without complex motorized tilting mechanisms or the like.

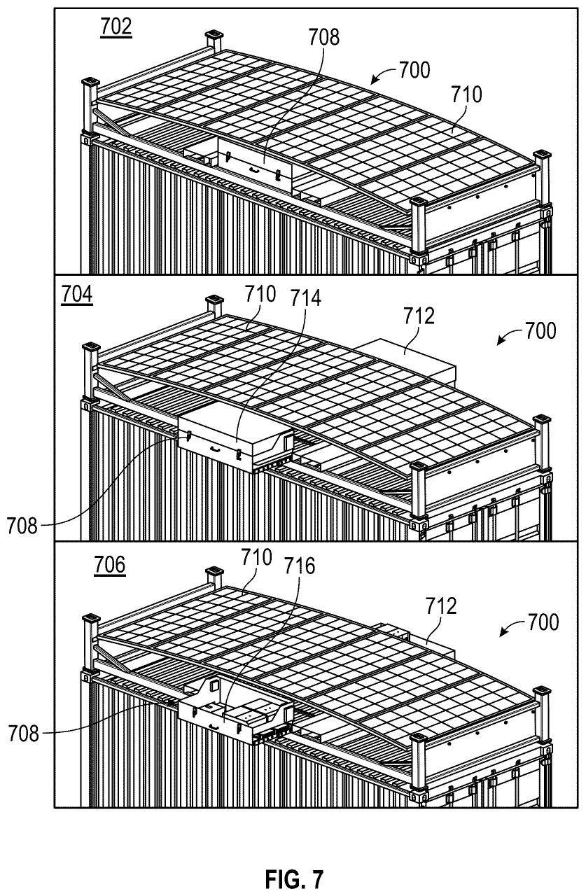

As can be seen from the side view of FIG. 4, curvature of the first array 114, the second array 116, and the third array 118 provides a space (open volume, recess, concavity, etc.) 120 beneath the first array 114, the second array 116, and the third array 118, for example between the base frame member 112 and the third array 118. The solar apparatus 100 includes least one enclosure 122 positioned in the space 120, between the base frame member 112 and the first array 114, the second array 116, and the third array 118. As described in further detail below with reference to FIGS. 7-12, the at least on enclosure 122 can house power electronics, inverters, batteries, control circuitry, etc. for facilitating generation of electricity from solar energy by the PV cells of the first array 114, the second array 116, and the third array 118. Advantageously, by being positioned in the space 120 provided by curvature of the first array 114, the second array 116, and the third array 118, the at least one enclosure 122 and electronics or other components contained are able to be transported and installed along with the rest of the solar apparatus 100 without requiring separate shipping and ordering of separate electronics components and installation in the field of separate electronics components, and the like. A complete, modular solar energy generation system is thereby provided by the solar apparatus 100.

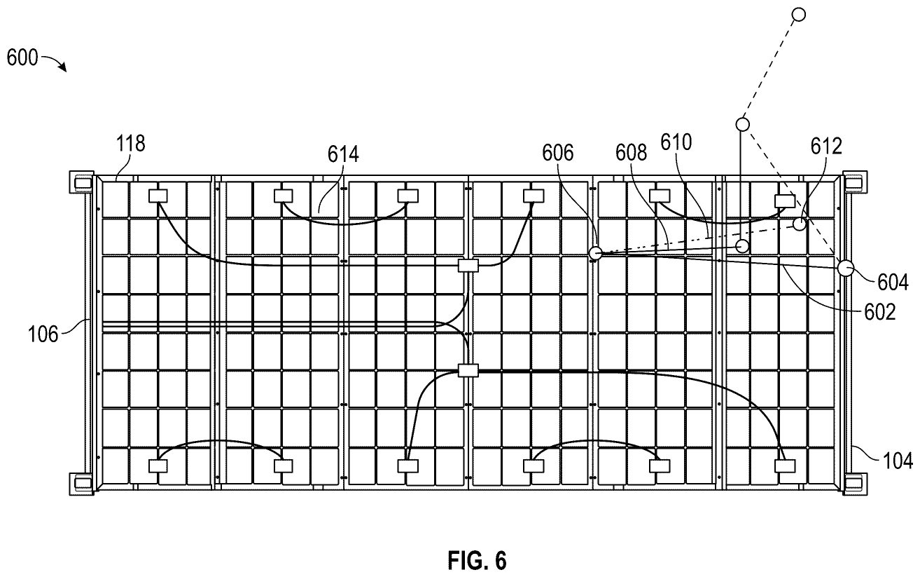

Referring now to FIGS. 6-7, a cable management system 600 included in the solar apparatus 100 is illustrated, according to some embodiments. The PV cells of first array 114, the second array 116, and the third array 118 are configured to output electrical current to electronics in the at least one enclosure 122 via conductive pathways (wires, cables). Because the second array 116 and the third array 118 are moveable relative to the enclosure 122, a cable management system 600 is provided to prevent such wires or cables from restricting movement of the second array 116 and the third array 118 while allowing repeated movement of the second array 116 and the third array 118 without requiring a user to disconnect and reconnect wires or cables.

As shown in FIGS. 6-7, the cable management system 600 includes a first arm 602 extending from a fixed point 604 on the first end 104 (i.e., a point fixed relative to the first end 104 of the solar apparatus 100) to a trolley 606 positioned on a track (rod) 608 coupled to an underside of the third array 118. The track 608 is fixed in position relative to the third array 118, while the trolley 606 is configured to translate (e.g., slide) along the track 608 and the first arm 602 is pivotally coupled to the trolley 606 and the fixed point 604. Movement of the third array 118 will accordingly cause the trolley 606 to translate along the track 608 while the first arm 602 rotates to maintain a rigid link between the track 608 and the fixed point 604 on the first end 104.

The cable management system 600 also includes a second arm 610 pivotally coupled to both the trolley 606 and a fixed point 612 on the third array 118 (i.e., a point fixed relative to the third array 118). Movement of the third array 118 will accordingly cause the trolley 606 to translate along the track 608 while the second arm 610 rotates to maintain a rigid link between the track 608 and the fixed point 612 on the third array 118.

The cable management system 600 is thereby structured such that the first arm 602 and the second arm 610 continue to define a path of constant length between the fixed point 604 on the first end 104 and the fixed point 612 on the third array 118. One or more cables (wires, sets of wires, etc.) 614 can thus run along this path of constant length, in particular from PV cells of the third array 118 to the fixed point 612 on the third array 118, along the second arm 610 to the trolley 606 and then along the first arm 602 to the fixed point 604 on the first end 104 (e.g., the one or more cables being coupled to the first arm 602 and the second arm 610). Because the path remains the same length through movement of the third array 118 relative to the first end 104, etc., the one or more cables 614 will maintain connection throughout the range of motion of the third array 118 without disconnecting, without inadvertently impinging movement of the third array 118, without bunching, tangling, etc., or otherwise obstructing easy and repeatable deployment and retraction of the third array 118.

Referring now to FIG. 7, a storyboard-style illustration showing operation of enclosures of a solar apparatus 700 is shown, according to some embodiments. The solar apparatus 700 as shown in FIG. 7 is configured substantially the same as the solar apparatus 100 described above, while omitting the second array 116 and the third array 118 such that a single-array solar apparatus 700 is shown in FIG. 7. The at least one enclosure 122 of the solar apparatus 100 described above may be configured as shown and described for the enclosures of the solar apparatus 700, in various embodiments (including solar apparatus 100).

The illustration of FIG. 7 shows operation of enclosures of the solar apparatus 700 in a first frame 702, a second frame 704, and a third frame 706 showing arrangement of elements of the solar apparatus 700 at different points in time. In the first frame 702, a first enclosure 708 is shown in a stowed position in a space created by curvature of an array 710 of PV cells of the solar apparatus 700. The first enclosure 708 is positioned at a longitudinal midpoint of the array 710 and the solar apparatus 700, so as to be positioned where the greatest vertical space is created under the array 710 by the curvature of the array 710. As arranged in the first frame 702, the first enclosure 708 is in a stowed position such that the enclosure is within the overall occupied which would already otherwise be occupied by the solar apparatus 700, such that the first enclosure 708 need not be installed separately, be dedicated additional space external to the solar apparatus 700, or the like.

To transition from the first frame 702 to the second frame 704, the first enclosure 708 moves (e.g., slides) from the stowed position as in the first frame 702 to an access position as shown in the second frame 704 in which the first enclosure 708 extends laterally from the array 710, i.e., is pulled out from under the array 710. The first enclosure 708 can be provided with a drawer mechanism or the like to facilitate the first enclosure 708 in being easily and selectively repositionable between the stowed position of the first frame 702 and the access position as in the second frame 704.

The second frame 704 also shows a second enclosure 712 of the solar apparatus 700 extending from an opposite lateral side of the array 710 as the first enclosure 708. The second enclosure 712 may be configured substantially the same as the first enclosure 708, such that the solar apparatus 700 includes enclosures accessible from either lateral side of the solar apparatus 700. The first enclosure 708 and the second enclosure 712 can be manually repositioned repeatedly by a user to transition between the first frame 702 and the second frame 704 (in either direction). In some embodiments, a cable management system similar to that shown in FIG. 6 is implemented to facilitate movement of the first enclosure 708 and the second enclosure 712.

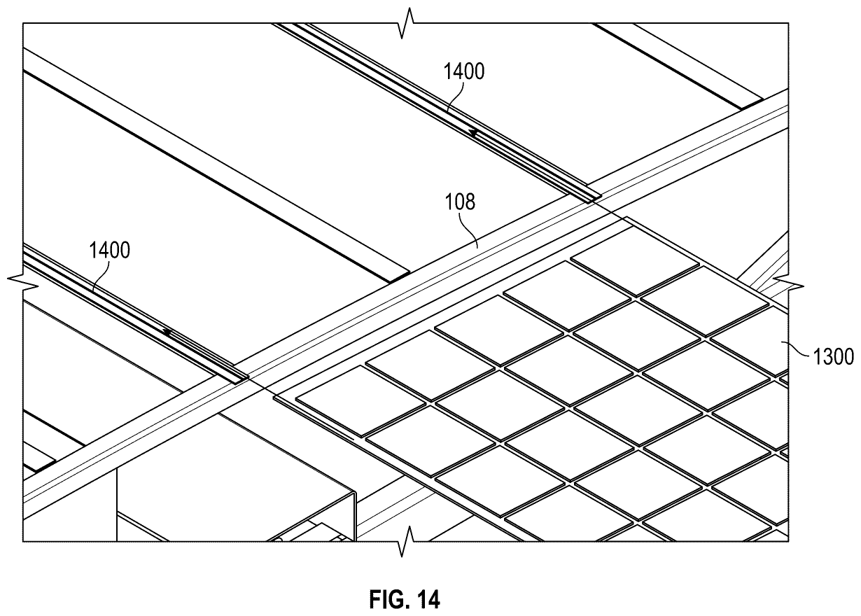

To transition for the second frame 704 to the third frame 706, the first enclosure 708 is opened. As shown, a cover 714 of the first enclosure 708 is lifted (e.g., removed, rotated) open to enable access to an interior of the first enclosure 708 and components located therein the cover 714 may be coupled by a hinge to a bottom portion 716 of the first enclosure 708 or may be a separate piece that can be lifted away from the bottom portion 716. With the cover 714 open, a person can access the contents of the first enclosure 708, for example power storage devices (e.g., batteries), power electronics (e.g., one or more inverters), control devices (e.g., a handheld controller as shown in FIG. 14, described below), or other tools or equipment which may be stored in the first enclosure 708 and/or the second enclosure 712.

The solar apparatus 100 can be transitioned from the arrangement shown in the third frame 706 back to the arrangement shown in the first frame 702 by closing the cover 714 of the first enclosure 708 (and similarly closing the second enclosure 712) and translating the first enclosure 708 and the second enclosure 712 toward a centerline of the array 710 so as to place the first enclosure 708 and the second enclosure 712 into the stowed positions illustrated in the first frame 702. The contents of the enclosures 708, 712 can thereby be repeated accessed and stowed.

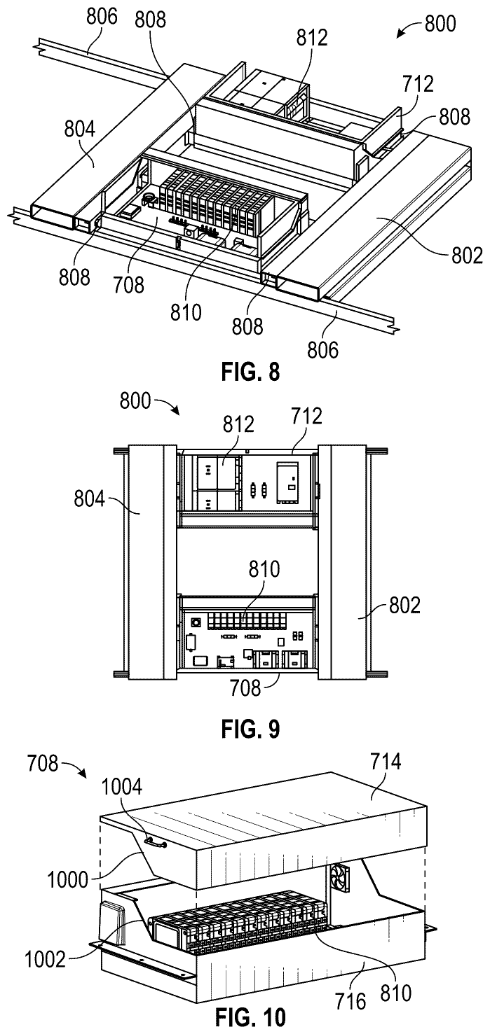

Referring now to FIGS. 8-9, detailed, cut-away views of an enclosure assembly 800 is shown, according to some embodiments. The enclosure assembly 800 includes the first enclosure 708 and the second enclosure 712 (shown with the cover 714 of the first enclosure 708 and a corresponding cover of the second enclosure 712 hidden). The enclosure assembly 800 is also shown as including a first beam 802 and a second beam 804 extending between longitudinal base frame members 806 of the solar apparatus 700 (e.g., base frame member 112 of the solar apparatus 100). The first beam 802 and the second beam 804 are coupled to the longitudinal base frame members 806 (e.g., welded, bolted, etc. thereto) so as to couple the enclosure assembly 800 to a remainder of the solar apparatus.

The first enclosure 708 and the second enclosure 712 are positioned between the first beam 802 and the second beam 804 and coupled to the first beam 802 and the second beam 804 via drawer mechanisms 808, for example to interior (medial) segments of the first beam 802 and the second beam 804. The drawer mechanisms 808 can be provided as tracks, wheels, extension members, slides, etc. configured to allow for sliding of the first enclosure 708 and the second enclosure 712 between stowed positions and access positions as shown in FIG. 7 and described above.

The first beam 802 and the second beam 804 are configured to receive forks of a standardized forklift. In particular, the first beam 802 and the second beam 804 are hollow, defining a channel (passage, opening, receptacle, etc.) through each of the first beam 802 and the second beam 804, and are spaced so as to be suitable for alignment with forks of a forklift (or telehandler, etc.). The first beam 802 and the second beam 804 are coupled to the base frame members 806 such that the entire solar apparatus can be moved by a forklift having forks extending into the first beam 802 and the second beam 804. The first beam 802 and the second beam 804 thereby facilitate installation, removal, repositioning, transportation, etc. of the solar apparatus, for example movement of the solar apparatuses herein into positions on mobile structures as arranged in FIGS. 1-4, 7, 20, for example.

As shown in FIGS. 7-8, the first enclosure 708 includes battery cells 810 the battery cells 810 are configured to store electrical energy generated by the PV cells of the arrays of the solar apparatus 700 (or solar apparatus 100), according to embodiments herein. Any number of battery cells 810 can be provided in various embodiments. In some embodiments, the battery cells 810 are sufficient in capacity to store and provide power for use by the mobile structure 102 or other electrical load at night or other low-sunlight period (e.g., when cloudy). In other embodiments, the battery cells 810 are adapted primarily for regulating the flow of electricity from the PV cells to an external electricity load or storage device.

As shown in FIGS. 8-9, the second enclosure 712 includes power electronics 812. The power electronics can include various circuitry, etc. for controlling the charging and discharging of the battery cells 810 and/or other operations of the electrical systems associated with the PV cells of the solar apparatuses herein. For example, the power electronics 812 may be adapted to convert direct current received from the PV cells to alternating current for transmission to an external electrical load and/or for use in charging the battery cells 810. Various configurations and functions of the power electronics 812 as may be suitable to enable electrical energy generation and use by the solar apparatus described herein can be provided in the second enclosure 712 in various embodiments. Various cabling, wiring, etc. can be provided between the first enclosure 708, the second enclosure 712, and the PV cells of the solar apparatus, for example via one or more cable management systems such as cable management system 600 of FIG. 6.

Referring now to FIG. 10, a perspective view of the first enclosure 708 is shown, according to some embodiments. The first enclosure 708 is shown as including the bottom portion 716, the cover 714, and the battery cells 810 positioned on the bottom portion 716 so as to be enclosed in the first enclosure 708 when the cover 714 is closed over the bottom portion 716. The cover 714 is shown as including a contoured bottom edge 1000 shaped complementary to a contoured top edge 1002 of the bottom portion 716 so as to facilitate mating of the cover 714 against the bottom portion 716 (e.g., with the contoured bottom edge 1000 of the cover 714 in contact with the contoured top edge 1002 of the bottom portion 716). The cover 714 can be mated against the bottom portion 716 so as to establish a weather-tight seal that substantially protects an interior of the first enclosure 708 (e.g., the battery cells 810) from ingress of precipitation or other moisture or debris. The cover 714 is shown as including a handle 1004 configured for use by a person lifting the cover 714 off of the bottom portion 716 and replacing the cover 714 on the bottom portion 716.

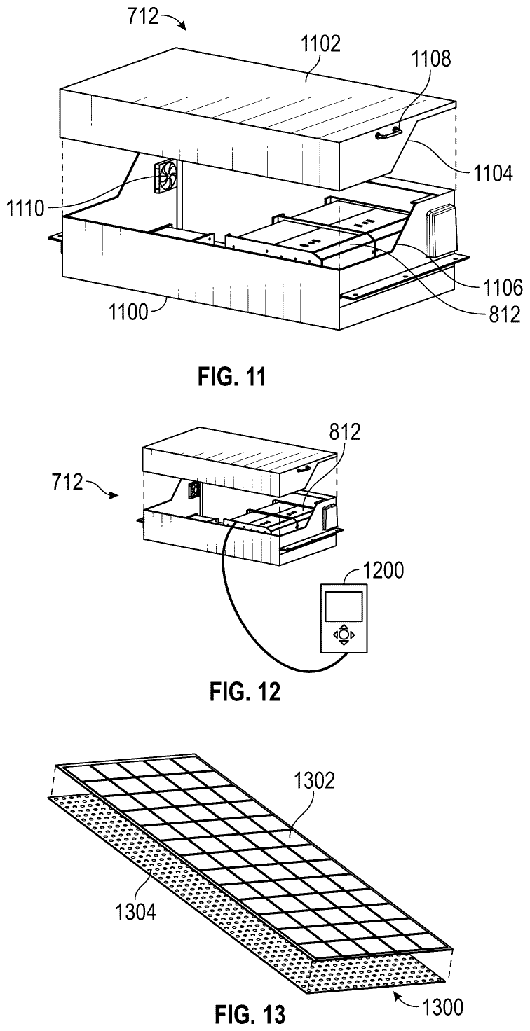

Referring now to FIG. 11, a perspective view of the second enclosure 712 is shown, according to some embodiments. The second enclosure 712 is shown as including a bottom portion 1100, a cover 1102, and the power electronics 812 positioned on the bottom portion 1100 so as to be enclosed in the second enclosure 712 when the cover 1102 is closed over the bottom portion 1100. The cover 1102 is shown as including a contoured bottom edge 1104 shaped complementary to a contoured top edge 1106 of the bottom portion 1100 so as to facilitate mating of the cover 1102 against the bottom portion 1100 (e.g., with the contoured bottom edge 1104 of the cover 1102 in contact with the contoured top edge 1106 of the bottom portion 1100). The cover 1102 can be mated against the bottom portion 1100 so as to establish a weather-tight seal that substantially protects an interior of the second enclosure 712 (e.g., the power electronics 812) from ingress of precipitation or other moisture or debris. The cover 1102 is shown as including a handle 1108 configured for use by a person lifting the cover 1102 off of the bottom portion 1100 and replacing the cover 1102 on the bottom portion 1100. The bottom portion 1100 is shown as including a fan 1110 configured to provide airflow to the interior of the second enclosure 712 for cooling of the power electronics 812.

Referring now to FIG. 12, an illustration showing a handheld controller 1200 in use with the power electronics 812 of the second enclosure 712 is shown, according to some embodiments. The handheld controller 1200 can be included with a solar apparatus (e.g., solar apparatus 100, solar apparatus 700) according to the teachings herein, and can be adapted for providing configuration and control inputs to the power electronics 812 for configuration, management, and control of electricity generation by the solar apparatus. The handheld controller 1200 can be a dedicated device delivered with the solar apparatus, for example provided in the second enclosure 712, for example along with a cable connecting the handheld controller 1200 to the power electronics 812. Inclusion of the handheld controller 1200 with a simple interface (e.g., limited buttons, etc.) can enable ease of installation, start-up, management, and maintenance in the field, for example in locations where networks for wireless communication with a smartphone application or the like may not be available and/or avoiding a scenario where a technician would rely upon access to a separate, external device which may not be readily available at the field site for deployment of the solar apparatus. Inclusion of the handheld controller 1200 can thereby contributed to the ease of deploying the solar apparatuses taught herein in any location. In some embodiments, the handheld controller 1200 may be replaced with a remote system (e.g., web based, app based, etc.). In some embodiments, the remote system may include a fuel gauge (e.g., a battery charge indication, etc.). In some embodiments, the remote system may include a manual state of charge (SOC) display to enable a user to perform a quick status check. In some embodiments, the solar apparatus may include a QR code configured to be scanned (e.g., to direct a device to an app or website, etc.). Referring now to FIGS. 13-16, various illustrations showing coupling of PV cells to the curved frame 108 of the solar apparatus 100 of FIGS. 1-5 (or comparable curved frame of the solar apparatus 700 of FIG. 7) are shown, according to various embodiments. Similar teachings can be implemented for coupling PV cells to moveable frames/panels (e.g., to provide the second array 116 and the third array 118).

FIG. 13 shows an exploded view of a photovoltaic (PV) panel 1300, according to some embodiments. The PV panel 1300 is shown as including a PV sheet 1302 coupled to a backing sheet 1304. The PV sheet 1302 includes multiple PV cells arranged in array covering a surface area of the PV sheet 1302. In some embodiments, the PV sheet 1302 is flexible, while the backing sheet 1304 is substantially rigid. The backing sheet 1304 is shown as being perforated, for example to facilitate heat dissipation.

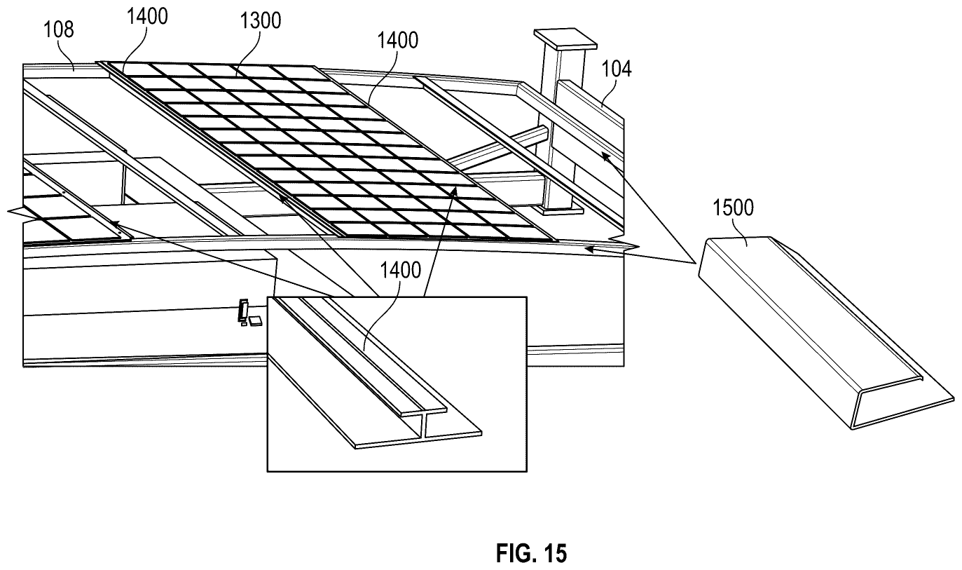

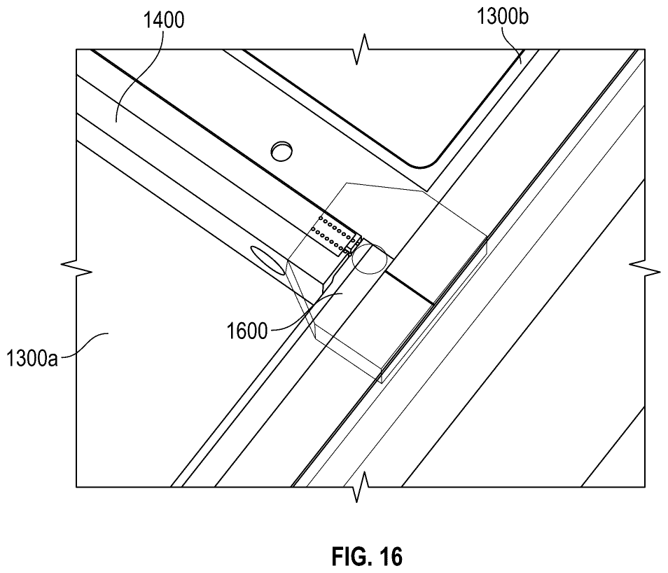

FIGS. 14-15 illustrated coupling of the PV panel 1300 to the curved frame 108 of the solar apparatus 100. In particular, as shown, the curved frame 108 includes a divider bars 1400 extending laterally across the curved frame 108 and spaced apart at a width corresponding to a width of the PV panel 1300. The divider bars 1400 are lipped (e.g., I-shaped) such that grooves are provided along either side of each divider bar 1400. As illustrated, the PV panel 1300 can be inserted into the grooves of neighboring divider bars 1400 to couple the PV panel 1300 to the curved frame 108. The curved frame 108 may receive multiple PV sub-panels 1300 in this manner, which combine to provide the first array 114 of PV cells as in FIGS. 1-5. As shown in FIG. 15, the curved frame 108 may include C-channel bars 1500 along the first end 104 and/or the second end 106 (rather than I-shaped divider bars 1400), so as to receive a PV panel 1300 from one direction. As shown in FIG. 16, neighboring PV sub-panels (shown as PV panel 1300a and PV panel 1300b) can be coupled tougher and to a divider bar 1400 by a bracket 1600 positioned at an end of the divider bar 1400.

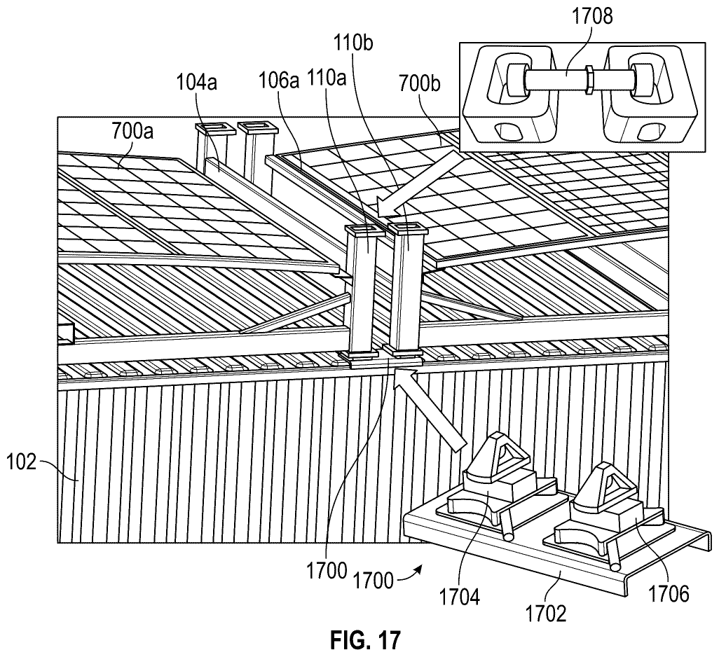

Referring now to FIG. 17, two solar apparatuses (shown as a first solar apparatus 700a and a second solar apparatus 700b) coupled to a top of a mobile structure 102 are shown, according to some embodiments. In the example shown, the solar apparatuses 700a, 700b are positioned end-to-end with a first end 104a of a first solar apparatus 700a adjacent a second end 106b of the second solar apparatus 700b, and with the first end 104a and the second end 106b positioned along the roof of the mobile structure 102 rather than at an end, corners, etc. of the mobile structure 102 (e.g., as in FIG. 1).

As shown in FIG. 17, a mount 1700 is used to couple the first solar apparatus 700a and the second solar apparatus 700b to the mobile structure 102. The mount 1700 is shown as including a base 1702, a first connector 1704 (e.g., dovetail connector, twist lock) coupled to the base 1702 and configured to interface with a post 110a of the first solar apparatus 700a, and a second connector 1706 (e.g., dovetail connector, twist lock) coupled to the base 1702 and configured to interface with a post 110b of the second solar apparatus 700b. The base 1702 is configured to couple to a roof, top, etc. of the mobile structure 102, for example by having a structure complementary to ridges, edges, recesses, projections, present on the roof, top, etc. of the mobile structure 102. The first connector 1704 an be received in the post 110a and the second connector 1706 can be received in the post 110b, as shown in FIG. 17, and then operated (e.g., rotated) to configuration in which the first connector 1704 is mechanically retained in the post 110a and the second connector 1706 is mechanically retained in the post 110b. FIG. 17 also shows that a clamp 1708 can be used at tops of the post 110a, 110b to couple the posts 110a, 110b of neighboring solar apparatuses together. The first solar apparatus 700a and the second solar apparatus 700b are thereby coupled together and to the mobile structure 102.

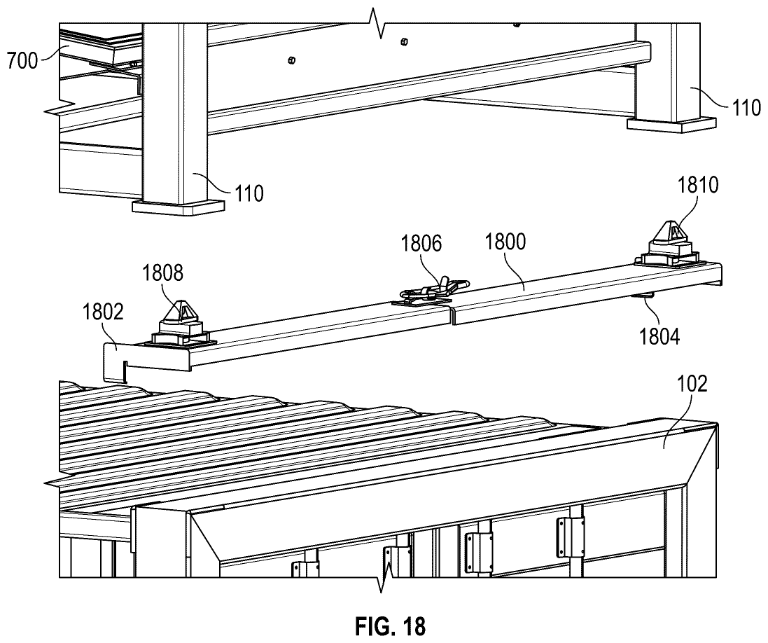

Referring now to FIG. 18, a mount 1800 for coupling a solar apparatus (shown as solar apparatus 700) to a mobile structure 102 is shown, according to some embodiments. The mount 1800 is implemented as a clamp extending laterally across the roof of the mobile structure 102, in particular having a first end 1802 extending to and structured to engage a first side of the mobile structure 102 and second end 1804 opposite the first end 1802 and extending to and structured to engage a second side of the mobile structure 102. The mount 1800 is shown as being of adjustable length between the first end 1802 and the second end 1804 and includes a tightener 1806 operable to change the length of the mount 1800, for example to reduce the length so as couple the mount 1800 to the mobile structure 102 by tightening, clamping, etc. the first end 1802 and the second end 1804 against opposite side walls of the mobile structure 102.

The mount 1800 also includes a first connector 1808 (e.g., dovetail connector, twist lock) proximate the first end 1802 and a second connector 1810 (e.g., dovetail connector, twist lock) 1812 proximate the second end 1804. The first connector 1808 and the second connector 1810 are configured to be received in posts 110 of the solar apparatus 700 and are operable to selectively retain the solar apparatus 700 on the mount 1800. The mount 1800 can thereby couple the solar apparatus 700 to the mobile structure 102.

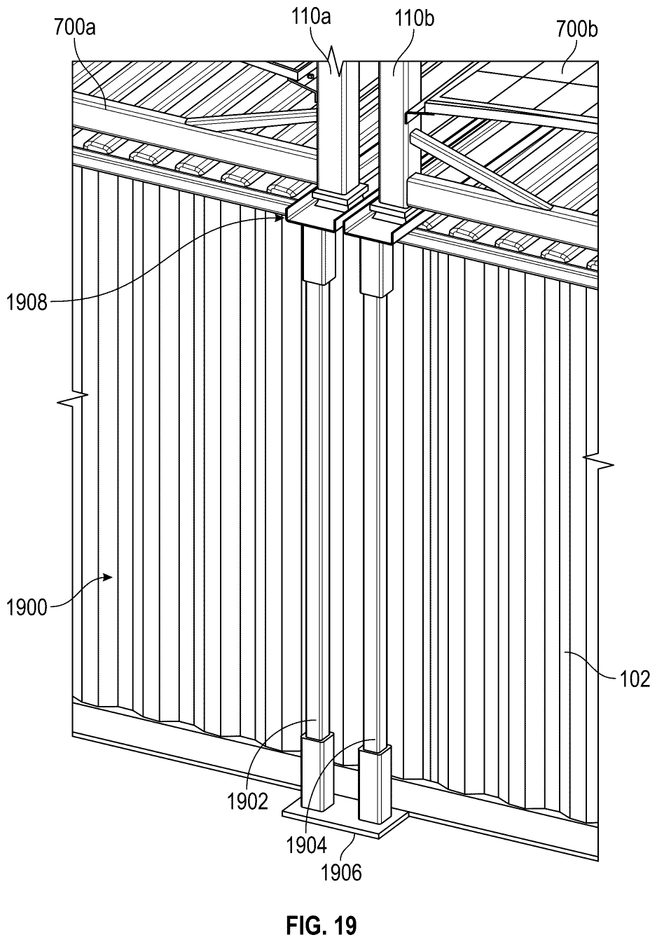

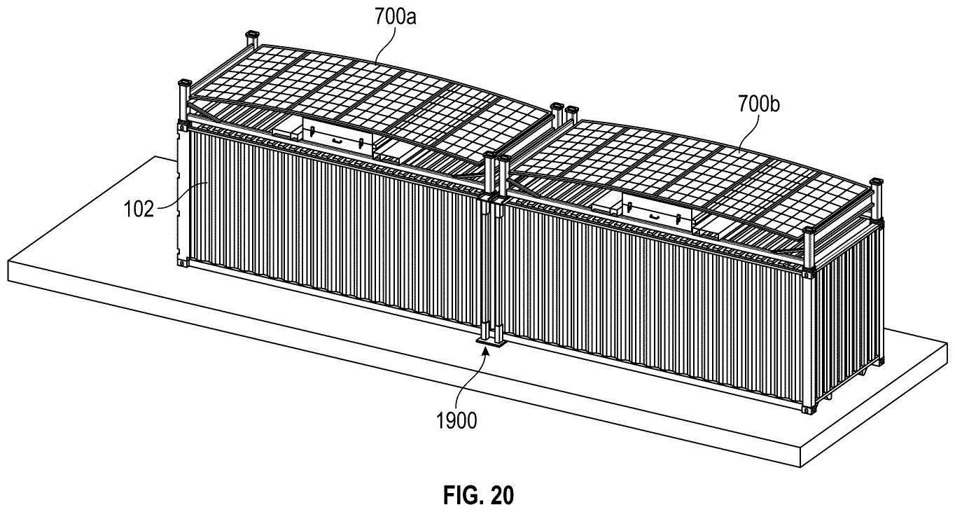

Referring now to FIGS. 19-20, a leg assembly 1900 for supporting one or more solar apparatuses (shown as a first solar apparatus 700a and a second solar apparatus 700b). The leg assembly 1900 is configured to support and retain one or more solar apparatuses 700a,b on a mobile structure 102. The leg assembly 1900 is shown as including a first leg 1902 and a second 1904 which extend from a foot 1906 (positioned on the ground, floor, etc.) upwards along a height of the mobile structure to a set of trays 1908. The trays 1908 are positioned along a roof, top, etc. of the mobile structure 102 and are configured to receive posts 110a,b of the first solar apparatus 700a and a second solar apparatus 700b. In some embodiments connectors such as the connectors illustrated in FIGS. 17-18 can be coupled to the trays 1908 to retain the posts 110 on the trays 1908. The trays 1908 can extend across the roof of the mobile structure 102 to one or more additional legs extending from the trays 1908 to an additional foot positioned on the ground, floor, etc. on an opposite side of the mobile structure 102 than the foot 1906 visible in FIG. 19. In some embodiments, the trays 1908 include a tightener, adjustment mechanism, etc., for example as for the mount 1800, so as to be adjustable in length. In some embodiments, the leg assembly 1900 can be used to support one or more solar apparatuses without the presence of a mobile structure 102.

As shown in FIG. 20 in some embodiments, the leg assembly 1900 is used where a first solar apparatus 700a meets a second solar apparatus 700b while both are positioned end-to-end along a mobile structure 102. Each solar apparatus 700a,b is shown as being half the length of the mobile structure 102 (E.g., as a standard shipping container), such that the leg assembly 1900 is used for mounting, support, etc. of the first solar apparatus 700a and the second solar apparatus 700b proximate a midpoint of the length of the mobile structure 102. As shown, at longitudinal ends of the mobile structure 102, different mounts or connectors are used than the leg assembly 1900, for example the mount 1800 or connectors (e.g., dovetail connectors, twist locks) interfacing with corner blocks of the mobile structure 102. Any combination of the various mounts, clamps, leg assemblies, connectors, etc. disclosure herein can be used to mounting of one or more solar apparatuses on one or more mobile structures, in various embodiments.

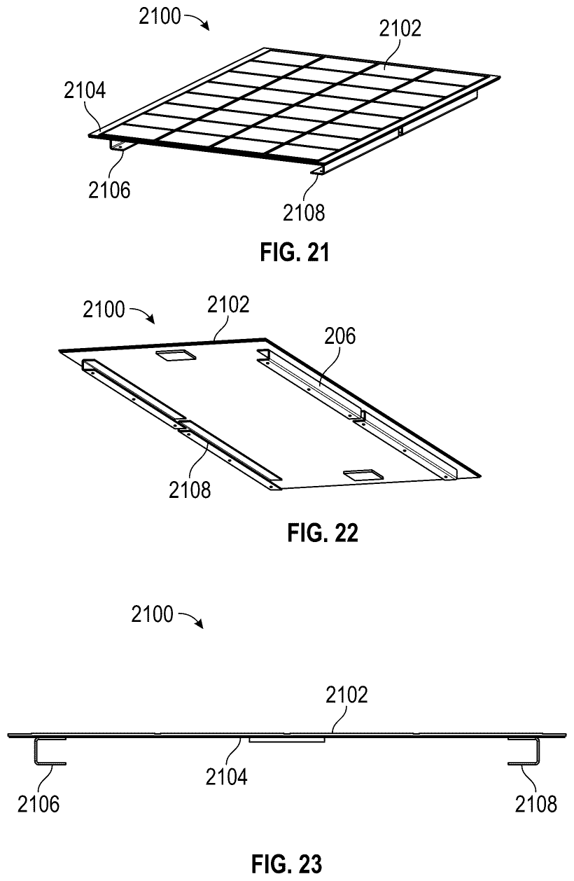

Referring now to FIGS. 21-23, illustrations of a panel 2100 are shown, according to some embodiments. The panel 2100 can be a component of a PV array of a solar apparatus, for example a component of the first array 114, second array 116, third array 118, or array 710 shown in various drawings and described elsewhere herein. FIG. 21 shows a top perspective view of the panel 2100, FIG. 22 shows a bottom perspective view of the panel 2100, and FIG. 23 shows an end view of the panel 2100.

The panel 2100 includes PV cells 2102, for example provided as a flexible sheet of PV cells. The panel 2100 also includes a backing sheet 2104 coupled to the PV cells 2102, such that the PV cells 2102 are mounted on the backing sheet 2104. The backing sheet 2104 may be flexible, for example less flexible than a sheet of PV cells 2102. For example, the backing sheet 2104 may be a flexible metal sheet.

The panel 2100 is also shown as including a first bracket 2106 and a second bracket 2108 coupled to the backing sheet 2104 such that the backing sheet 2104 is between the first bracket 2106 and the PV cells 2102 and between the second bracket 2108 and the PV cells 2102. The first bracket 2106 and the second bracket 2108 extend along the backing sheet 2104 at opposing lateral sides of the backing sheet 2104. As shown, the first bracket 2106 and the second bracket 2108 are C-shaped or U-shaped, within an open side of the first bracket 2106 facing an open side of the second bracket 2108 and vice versa.

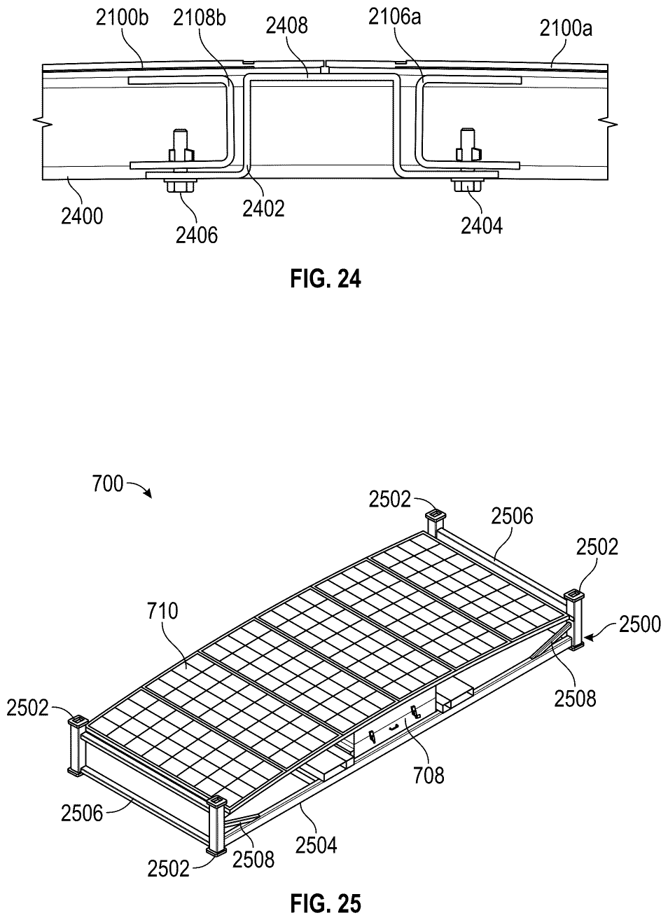

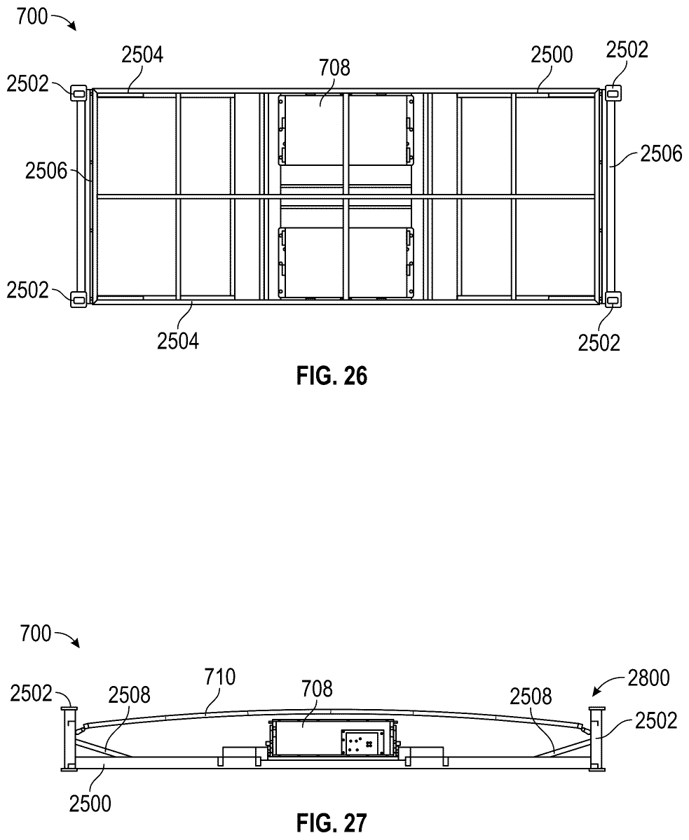

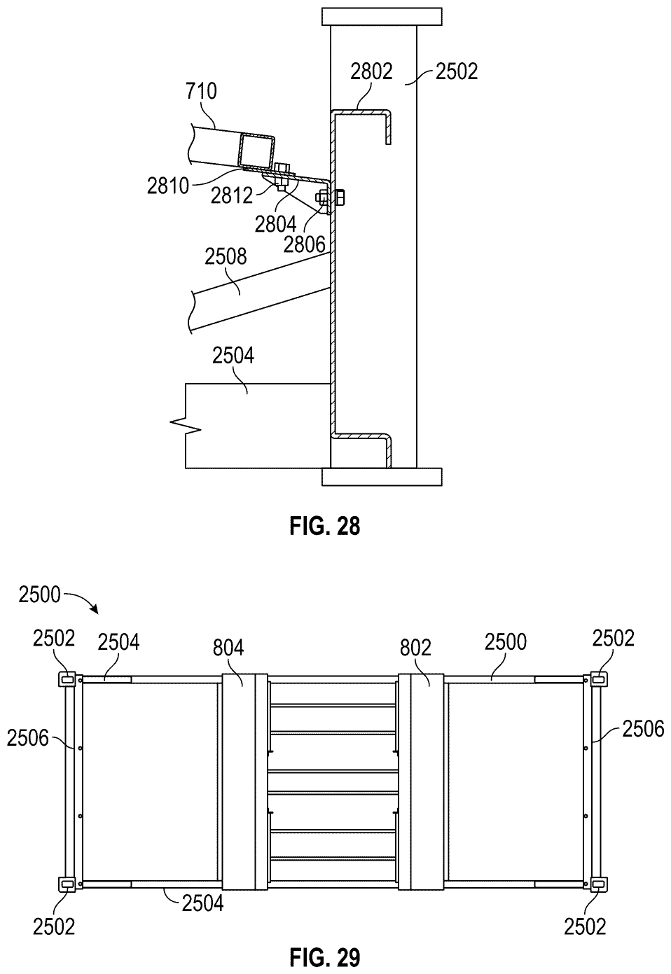

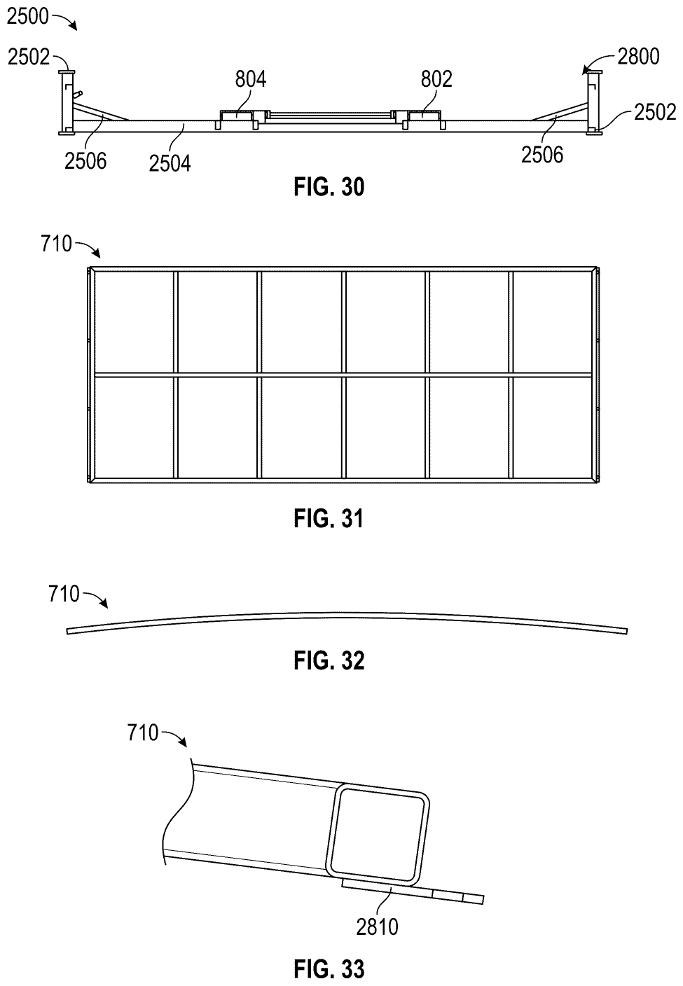

Referring now to FIG. 24, an illustration showing coupling of a first panel 2100a and a second panel 2100b to a frame 2400 is shown, according to some embodiments. The frame 2400 may be the curved frame 108, for example. A mounting bracket 2402 is coupled to the frame 2400, for example extending perpendicular to the frame 2400 (e.g., in a lateral direction of a solar apparatus). The mounting bracket 2402 is shaped to receive the first bracket 2106a of a first panel 2100a and the second bracket 2108b of a second panel 2100b as illustrated in FIG. 24. As shown in FIG. 24, a first fastener (e.g., bolt, screw, pin, rivet) 2404 couples the first bracket 2106a to the mounting bracket 2402 and a second fastener 2406 couples the second bracket 2108b to the mounting bracket 2402. As shown, the mounting bracket 2402 may including a top portion 2408 arranged to abut, support, etc. backing sheets of the first panel 2100a and the second panel 2100b.Referring now to FIGS. 25-33, additional views of the solar apparatus 700 and components thereof are shown, according to some embodiments. The solar apparatus 700 includes a base frame 2500, a curved array 710 coupled to the base frame 2500, and an enclosure 708 coupled to the base frame 2500. FIG. 25 shows a perspective view of the solar apparatus 700, FIG. 26 shows a bottom view of the solar apparatus 700, and FIG. 27 shows a side view of the solar apparatus 700. FIG. 28 shows a side view of an end portion 2800 of the solar apparatus 700. FIG. 29 shows a top view of the base frame 2500 and FIG. 30 shows a side view of the base frame 2500, while FIG. 30 shows a top view of the curved array 710, FIG. 32 shows a side view of the curved array 710, and FIG. 33 shows a detailed view of an end portion of the curved array 710.

The base frame 2500 is shown as including corner posts 2502, longitudinal members 2504 and lateral member 2506 arranged in a substantially rectangular shape. The base frame 2500 is also shown as including angled braces 2508 between the corner posts 2502 and the longitudinal members 2504. The base frame 2500 is also shown as including a first beam 802 and a second beam 804 extending between the longitudinal members 2504. The curved array 710 is shaped to substantially optimize the maximum area of photovoltaic cells fitting between the corner posts 2502.

The base frame 2500 is coupled to the curved array 710 at end portions of the solar apparatus 700, for example at an end portion 2800 denoted in FIG. 27 and shown in detailed in FIG. 28. The end portion 2800 includes a corner post 2502, which is shown as including a reinforcing plate 2802 which extends substantially vertically along the corner post 2502. The end portion 2800 is also shown as including a bracket 2804 extending substantially horizontally from the corner post 2502 and the reinforcing plate 2802. The bracket 2804 is shown as being L-shaped and as being coupled to the corner post 2502 and the reinforcing plate 2802 by a first fastener 2806. The end portion 2800 also includes a plate 2810 coupled to the solar apparatus 700 such that the plate 2810 extends from an underside of a longitudinal end of the curved array 710. The plate 2810 is coupled to the bracket 2804 by a second fastener 2812. The curved array 710 is thereby coupled to the base frame 2500 via the plate 2810 and the bracket 2804.

Similar end structures can be provided at multiple (e.g., four) corner posts 2502 of the base frame 2500. Advantageously, the curved array 710 can be easily installed, uninstalled, replaced, etc. by selectively unfastening and fastening the first fastener 2806 of each end structure. In some embodiments, the coupling between the curved array 710 and the corner posts 2502 is slidable, for example to provide a multi-array design as in FIGS. 1-5C. In some embodiments, a given curved array 710 can be interchangeably used in a single-array apparatus, a multi-array apparatus, or as a standalone device.

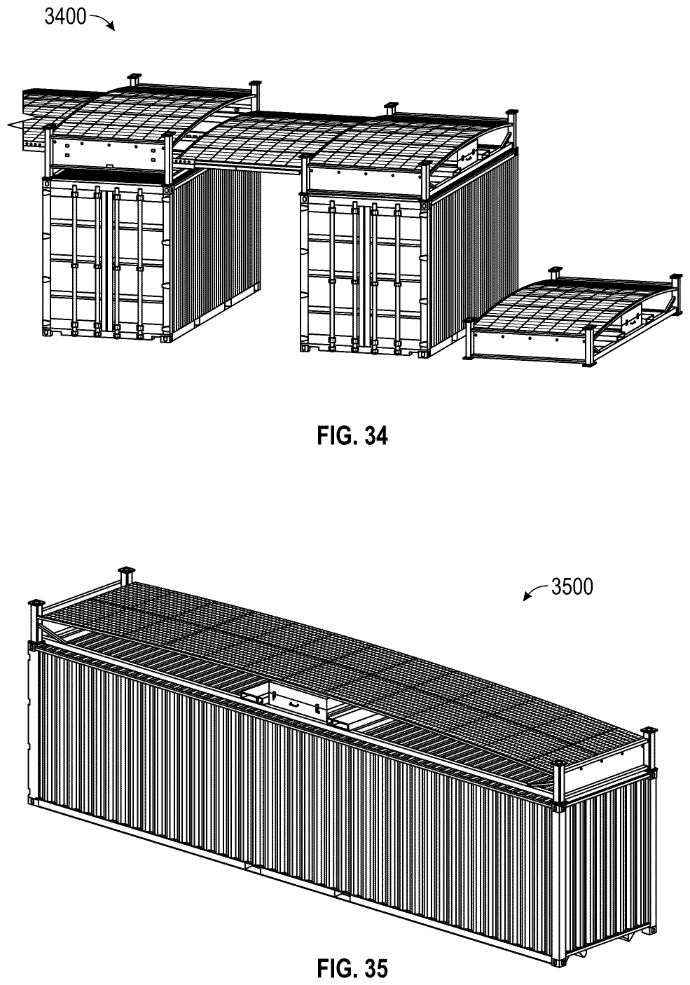

Referring now to FIG. 34, a system 3400 including multiple solar apparatuses is shown, according to some embodiments. FIG. 34 illustrates that any combination of any number of implementations of the solar apparatus 100, the solar apparatus 700, and/or other adaptations of the teachings herein can be deployed together. For example, a solar apparatus according to the teachings herein can be deployed on a mobile structure, as a canopy connecting two mobile structures spaced apart by a length or width of the solar apparatus or supported by some other structure, mount, etc., directly on the ground or any other support surface as a stand-alone apparatus, and/or any other configuration. In some embodiments, electronics stored in enclosures thereof are configured to coordinate energy collection, storage, discharge, and other operations across the system 3400 of multiple solar apparatuses.

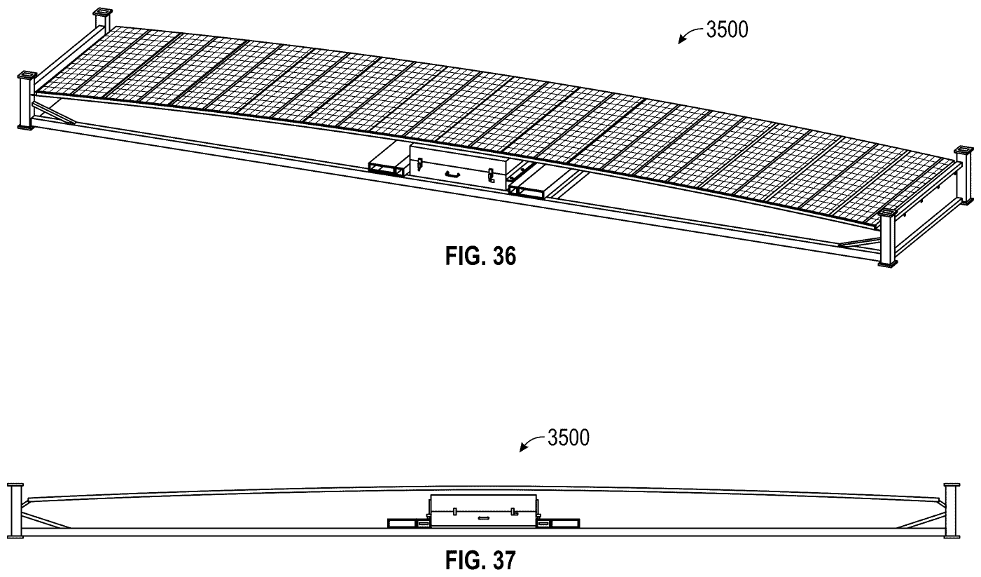

Referring now to FIGS. 35-37, views of a solar apparatus 3500 are shown, according to some embodiments. The solar apparatus 3500 may be configured substantially according to the teachings above, but may have different dimensions. For example, the solar apparatus 3500 of FIGS. 35-37 may be approximately 40 feet by 8 feet while the solar apparatus 700 and/or the solar apparatus 100 described above may be approximately 20 feet by 8 feet. The drawings thereby illustrate that the solar apparatuses according to the teachings herein can have any suitable dimension, for example a dimension based on the dimensions of a mobile structure (or permanent structure) on which the solar apparatuses are to be placed. In some embodiments, such dimensions are based on various different shipping container dimensions that may be set by a standards-setting body.

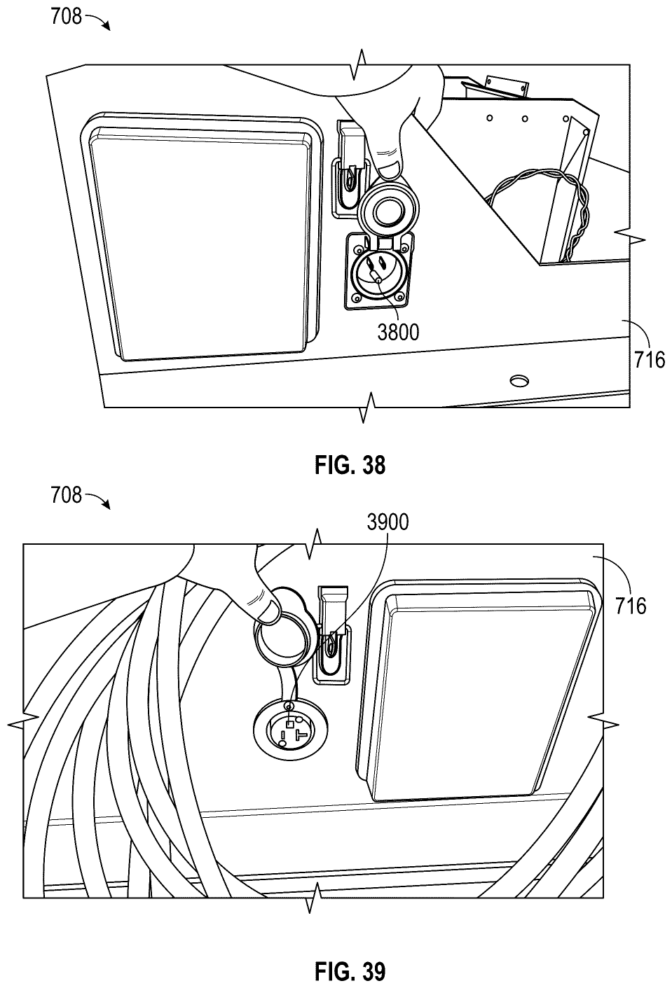

Referring now to FIGS. 38-40, additional views of a first enclosure 708 of any of the solar apparatus herein are shown, according to some embodiments. FIGS. 38-40 illustrate that the first enclosure 708 can include one or more inlet plugs and/or outlet plugs to enable access to power generated by and/or stored by the solar apparatus and/or to provide power to the solar apparatus (e.g., to charge batteries therefore (e.g., battery cells 810)). The second enclosure 712 (or any other or additional enclosure in various embodiments) may include similar inlet(s) and/or outlet(s), in various embodiments. While FIGS. 38-40 show standardized plug structures as used in certain geographies (e.g., United States), the present disclosure contemplates any and all changes to such structures (and associated voltages, currents, etc.) for adaptation of the teachings herein for use with different electrical plug standardization in other geographies.

FIG. 38 shows an inlet 3800 positioned on the lower portion 716 of the first enclosure 708. The inlet 3800 is shown as a 120 volt alternating current (VAC) inlet. The inlet 3800 is configured to interface with a power cord/cable (e.g., a standard extension cord) to receive electricity (e.g., 120 VAC) from an external source, for example from an external generator (e.g., internal combustion generator, other solar array, wind turbine, other renewable energy generator, etc.), energy storage (e.g., battery system), or the electricity grid. Power electronics of the first enclosure 708 can be adapted to receive and use the electricity from the inlet 3800, for example in power operations of the solar apparatus when insufficient solar energy is available and/or for charging such received electrical energy into batteries of the solar apparatus. As shown in FIG. 38, the inlet 3800 can be recessed into the lower portion 716 of the first enclosure 708 and can include a cover (e.g., a hinged cover) configured to protect the inlet 3800 (e.g., from ingress of debris, moisture, etc.) when not in use.

FIG. 39 shows an outlet 3900 positioned on the lower portion 716 of the first enclosure. The outlet 3900 is shown as a 120 VAC outlet. The outlet 3900 is configured to interface with a power cord/cable (e.g., a standard extension cord, a power cord of an electrical appliance) to provide electricity (e.g., 120 VAC) from the solar apparatus to an external device (e.g., any appliance, device, tool, electronic, etc. which uses electrical power). The outlet 3900 may also be configured to transfer electricity to an external source, for example for storage in an external energy storage (e.g., battery system) or to the electrical grid. The outlet 3900 is conductively coupled to power electronics of the lower portion 716 so as to receive electricity at a standardized voltage (e.g., 120 VAC) for output to such external device (e.g., from battery cells 810, from solar cells outputting electricity, etc.). The outlet 3900 can thereby provide a user-friendly, quick, and easy path for accessing power generated by and/or stored on a solar apparatus for consumption by any electrical device (e.g., computer(s), air conditioner, heater, fan, external battery pack, lighting, power tool, other appliance, etc.). As shown in FIG. 39, the outlet 3900 can include a cover (e.g., a flexible cover) configured to protect the outlet 3900 (e.g., from ingress of debris, moisture, etc.) when not in use.

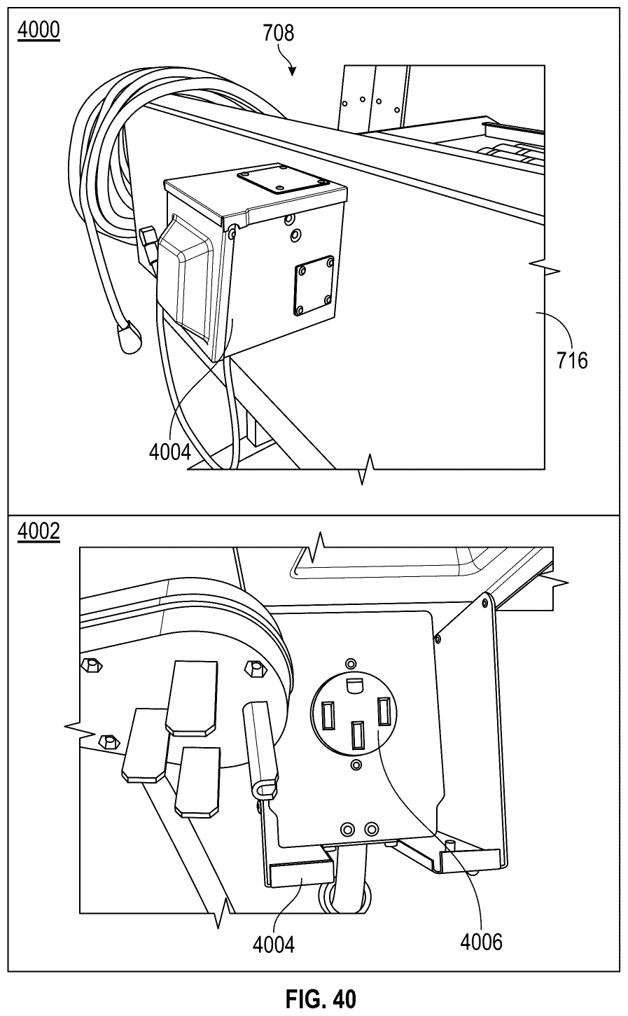

FIG. 40 shows a series of views, in particular a first frame 4000 and a second frame 4002, illustrating operation of a housing 4004 in which an outlet 4006 is disposed. The housing 4004 is shown as being coupled to the lower portion 716 of the first enclosure 708. The housing 4004 includes a hinged cover which enables access to an interior volume in which the outlet 4006 is positioned. As shown, the outlet 4006 is a 50 amp outlet (e.g., 120/240 VAC outlet). The outlet 4006 can provide for higher voltage, higher amperage, etc. as compared to the outlet 3900, for example adapted to provide electrical input to an electrical power system of a mobile building, for electrical vehicle charging, and/or for any other system or appliance which operates on such an electricity source. The outlet 4006 is conductively coupled to power electronics of the solar apparatus which provide electricity at the desired amperage, voltage, etc. (e.g., at standardized values), as sourced from batteries and/or solar cells of the solar apparatus. As illustrated in the first frame 4000 and the second frame 4002, the housing 4004 can provide for selective access to (e.g., for plugging and unplugging) and protection of (e.g., protection from ingress of debris, moisture, etc.) the outlet 4006 by a user via manual manipulation.

Advantageously, the inlet 3800, the outlet 3900, and the outlet 4006 provide various options for provide electricity to and receiving electricity from solar apparatus according to the teachings herein. The solar apparatuses herein can thereby be adapted to be easily and quickly connected to a wide variety of external devices, electrical systems, etc. without requiring direct electrical wiring (e.g., without requiring an electrician or other expert technician). Such features can easy mobile deployment of the solar apparatuses herein for use with temporary buildings, storage containers, mobile buildings, mobile offices, etc. across a wide variety of uses cases, including for directly power external electrical appliances without intermediate electrical infrastructure.

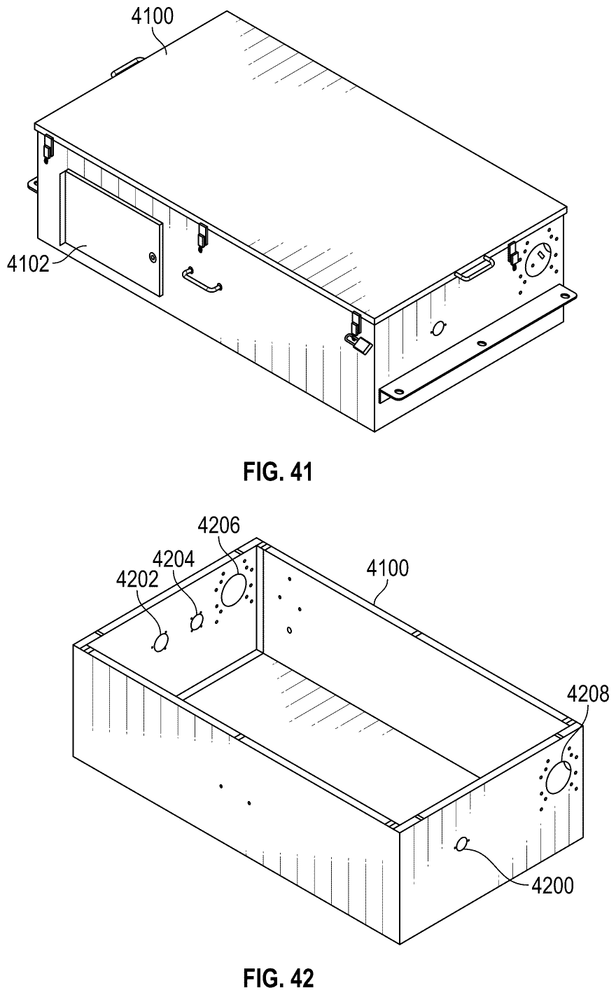

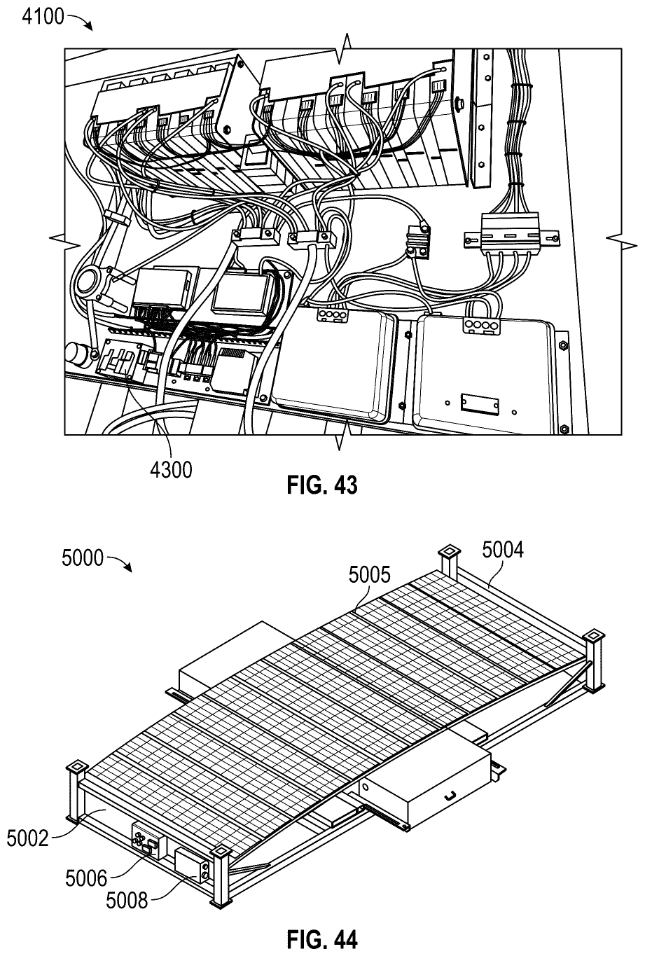

Referring now to FIGS. 41-43, perspective views of an enclosure 4100 are shown, according to some embodiments. The enclosure 4100 can be used as an enclosure 122 of any of the solar apparatus taught herein (e.g., as another embodiment of the first enclosure 708 or the second enclosure 712). As shown in FIG. 41, the enclosure 4100 includes an access door 4102 which can be opened to provide easy access to an interior of the enclosure 4100, for example without the user needing to displace the enclosure 4100 from its stowed position as discussed with reference to FIG. 7 above. The access door 4102 is configured to be locked to prevent unofficial access to controls within the enclosure 4100 (e.g., to prevent access to activation and deactivation controls mounted within the enclosure 4100, etc.). FIG. 43 illustrates that various switches, breakers, resets, and/or other components which a user may be likely to desire to access (shown as accessible electronics 4300) can be positioned inside the enclosure 4100 proximate the access door 4102 such that the accessible electronics 4300 are easily accessible via the access door 4102.

FIG. 42 illustrates that the enclosure 4100 includes a variety of openings configured to allow cabling, inlets, outlets, etc. to reach the exterior of the enclosure. In particular, as shown, the enclosure 4100 includes a first port 4200 for the outlet 3900 (e.g., 120 VAC outlet), a second port 4202 for the inlet 3800 (shown as located on an opposite side of the enclosure 4100 as the first port 4200), and a third port 4204 for the outlet 3900 (e.g., 50 Amp outlet, 240 VAC outlet). The enclosure 4100 is also shown as including a fourth port 4206 and a fifth port 4208 to facilitate any other electrical access that may be desirable to the enclosure (e.g., for added direct wiring as may be desirable for customizability in various deployments). The enclosure 4100 is thereby structured to enable the various electrical connections described above.

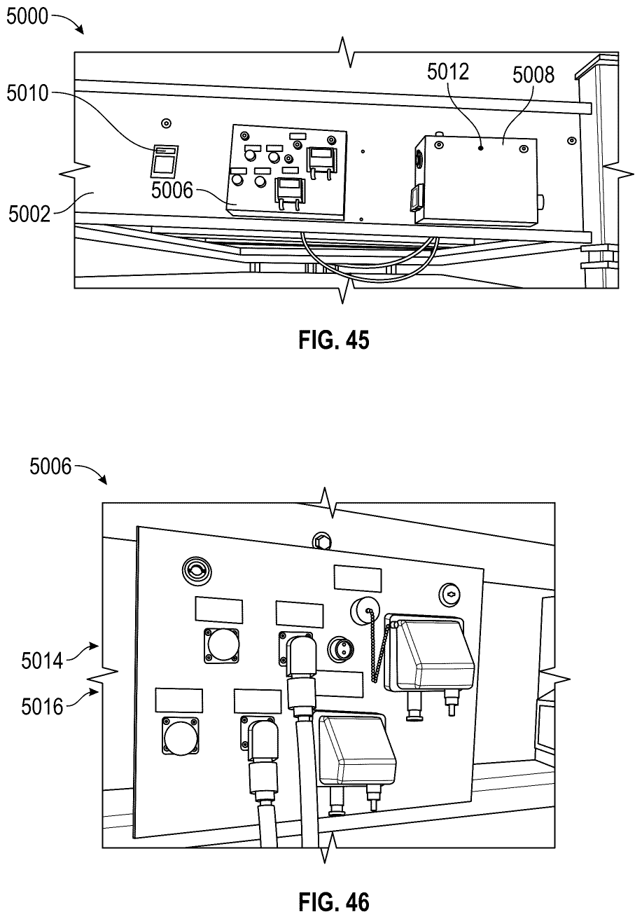

FIG. 44 illustrates a solar apparatus 5000, according to some embodiments. The solar apparatus 5000 as shown in FIG. 44 is configured substantially the same as the solar apparatus 700 described above. A first end 5002 of the solar apparatus 5000 is opposite a second end 5004 of the solar apparatus 5000 and an array 5005 extends between the first end 5002 and the second end 5004. The first end 5002 includes a first junction box, shown as DC junction box 5006, and a second junction box, shown as AC junction box 5008. The first end 5002 of the solar apparatus 5000, including the DC junction box 5006 and the AC junction box 5008, are also illustrated in FIG. 45. The first end 5002 of the solar apparatus 5000 also includes a QR code 5010. A user scans the QR code 5010 to direct the user to an app or website. The app or website includes information regarding the solar apparatus 5000 (e.g., a customer group, a unit type, a number of racks, a charge state, a system temperature, power output, generator information, a state of charge (SOC), etc.). In some embodiments, the app or website includes a map of locations of all solar apparatuses. In some embodiments, the app or website includes information on a specific solar apparatus (e.g., a serial number, a battery level, solar power, load power, diesel CO2 emissions reduced, a location, a customer, a unit type, etc.). In some embodiments, the app or website allows for remote HVAC control. In some embodiments, the app or website reports out data summaries. In some embodiments, the app or website sends alerts (e.g., emails, texts, etc.) when a low state of charge is detected.

The AC junction box 5008 includes an LED 5012 (e.g., a light source, etc.) centered on a side of the AC junction box 5008 configured to face away from the array 5005 (e.g., toward a user, etc.). The LED 5012 turns on (e.g., illuminates, emits light, etc.) when the AC junction box 5008 is active, and the LED 5012 turns off (e.g., ceases to emit light, etc.) when the AC junction box 5008 is inactive. In some embodiments, the LED 5012 emits a first color when the AC junction box 5008 is active, emits a second color when the AC junction box 5008 is inactive, and the first color different than the second color (e.g., the first color is green and the second color is red, etc.). In some embodiments, the LED 5012 emits a first pattern of light when the AC junction box 5008 is active, and emits a second pattern of light when the AC junction box 5008 is inactive (e.g., the LED 5012 flashes every 1 second when the AC junction box 5008 is active and flashes every 5 seconds when the AC junction box 5008 is inactive, etc.). Coupling the DC junction box 5006 and the AC junction box 5008 to the first end 5002 of the solar apparatus 5000 enables a user (e.g., a technician, etc.) to easily access the various electrical connections instead of using an electrician to direct wire during installation.

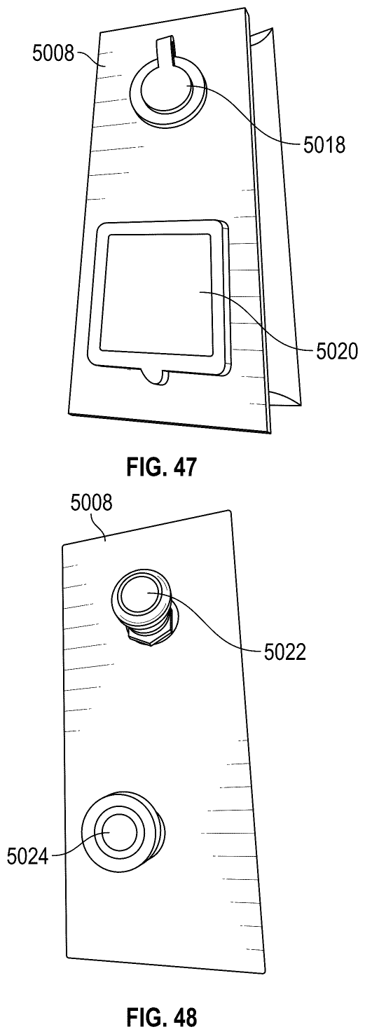

Referring now to FIG. 46, the DC junction box 5006 includes a plurality of inlets 5014 (e.g., positive battery inlets, negative battery inlets, auxiliary inputs, remote-back up HVAC control connection, remote back-up generator control connection, etc.) and a plurality of outlets 5016 (e.g., positive battery inlets, negative battery inlets, etc.). Referring now to FIG. 47, a first side of the AC junction box 5008 includes an outlet 5018 and an inlet 5020. In the illustrated embodiment, the outlet 5018 is a 120 VAC outlet and the inlet 5020 is a 250 VAC/50A inlet. In some embodiments, the outlet 5018 may electrically couple to a generator. In other embodiments, the outlet 5018 and the inlet 5020 may be alternate voltages and frequencies (e.g., 240 VAC, etc.). Referring now to FIG. 48, a second side of the AC junction box 5008 includes a stop 5022 (e.g., a shut-off switch, etc.) and an outlet 5024. In the illustrated embodiment, the outlet 5024 is a 240/120 VAC power out connection. In other embodiments, the outlet 5024 may be alternate voltages and frequencies (e.g., 220/380 VAC, etc.). The first side of the AC junction box 5008 confronts the DC junction box 5006, and the second side of the AC junction box 5008 is opposite the first side of the AC junction box 5008.

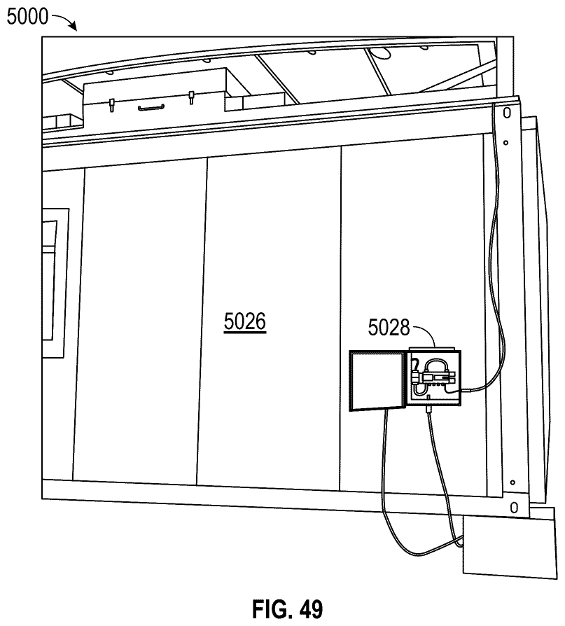

Referring now to FIG. 49, the solar apparatus 5000 deployed on a mobile structure 5026. A side of the mobile structure 5026 includes an automatic transfer switch (ATS) 5028 electrically coupled to the solar apparatus 5000. The ATS 5028 is configured to switch a load between multiple power sources and may be used to monitor a quantity of power and switch to an alternate source if the primary source fails to meet a criterion (e.g., voltage or frequency, etc.).

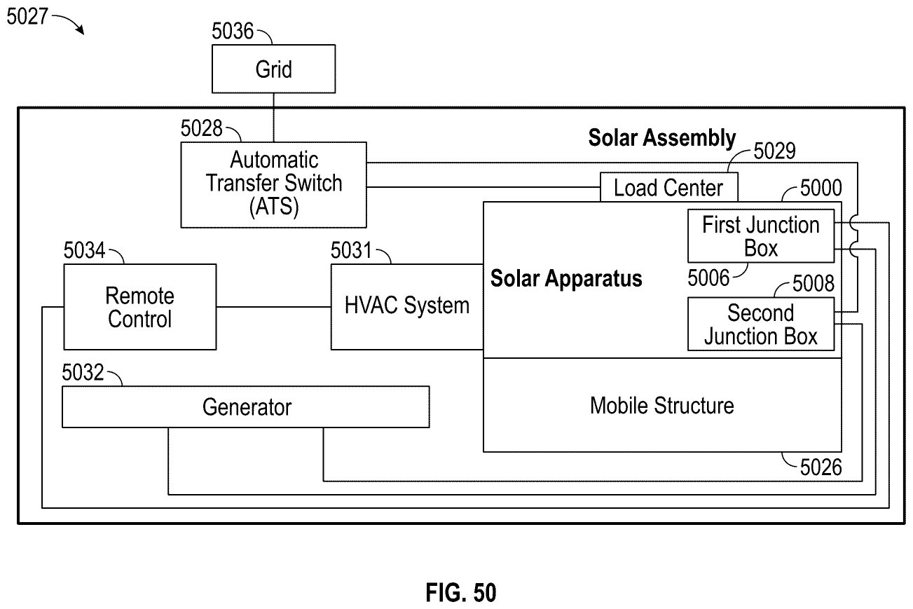

FIG. 50 shows a block diagram of a solar assembly 5027 including the mobile structure 5026. The solar assembly 5027 also include an HVAC system 5031, the automatic transfer switch (ATS) 5028, a load center 5029 (e.g., panel, etc.), a generator 5032 (e.g., a power source, back-up generator, etc.), and a remote control 5034. Each of the HVAC system 5031, the first solar junction box 5006, and the generator 5032 may be controlled by the remote control 5034 (e.g., remote device, etc.). The remote control 5034 may control the HVAC system 5031 to power the HVAC system 5031 on or off, create run schedules. The remote control 5034 may also include an emergency off mechanism, where the HVAC system 5031 can be turned off from the remote control 5034. The remote control 5034 may control a back-up generator function for the generator 5032. The ATS 5028 is configured to monitor the status of and receive input from both the solar apparatus 5000 and a grid 5036. The generator 5032 is electrically coupled to the first junction box 5006 (e.g., via the inlet 5020, etc.) and the second junction box 5008. The ATS 5028 is electrically coupled to the second junction box 5008, the load center 5029, and the grid 5036. Power can be provided to the HVAC system 5031 and/or to electrical loads connected to the load center 5029 via connections illustrated in FIG. 50, in various embodiments. The solar assembly 5027 can thereby provide a fully-contained microgrid, in some embodiments.

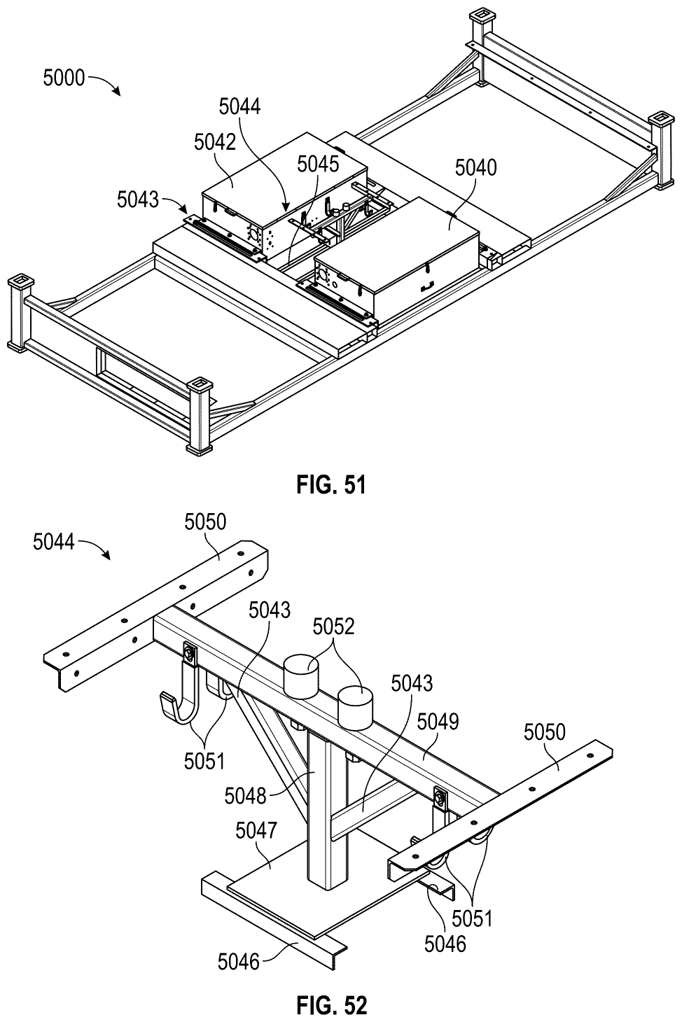

FIG. 51 illustrates a portion of the solar apparatus 5000, according to some embodiments. The solar apparatus 5000 includes a first enclosure 5040, a second enclosure 5042, a plurality of drawer mechanisms 5030, a plurality of rails 5045 (e.g., beams, supports, etc.), and a cable management frame 5044 (e.g., cable organization system, etc.). The first enclosure 5040 and the second enclosure 5042 are substantially similar to the enclosure 4100. In the illustrated embodiment, the first enclosure 5040 is an AC enclosure and the second enclosure 5042 is a DC enclosure. The first enclosure 5040 and the second enclosure 5042 are coupled to the drawer mechanisms 5030, and the drawer mechanism 5030 are configured to allow the first enclosure 5040 and the second enclosure 5042 to slide in and out of the solar apparatus 5000. The cable management frame 5044 extends between the first enclosure 5040 and the second enclosure 5042 and is received by the plurality of rails 5045. The plurality of rails 5045 extend parallel to the first enclosure 5040 and the second enclosure 5042.

Referring now to FIG. 52, a perspective view of the cable management frame 5044. The cable management frame 5044 includes a plurality of lateral rails 5046 and a base 5047 extending from and between the rails 5046 of the solar apparatus 5000. The lateral rails 5046 of the cable management frame 5044 are configured to couple to the rails 5045 of the solar apparatus 5000. The cable management frame 5044 includes a vertical portion 5048, a longitudinal portion 5049, and a plurality of braces 5043 (e.g., reinforcements, diagonal portions, etc.). The vertical portion 5048 extends substantially perpendicular to and from the base 5047 to the longitudinal portion 5049. The vertical portion 5048 is centered on the longitudinal portion 5049. The longitudinal portion 5049 extends substantially parallel to the first enclosure 5040 and the second enclosure 5042. The braces 5043 extend between the vertical portion 5048 and the longitudinal portion 5049. The cable management frame 5044 also includes one or more lateral portions 5050, a plurality of hooks 5051 (e.g., hanger, etc.), and bumpers 5052 (e.g., spacers, etc.) extending from the longitudinal portion 5049. The lateral portions 5050 extend substantially perpendicular to a first end and a second end of the longitudinal portion 5049. The plurality of hooks 5051 are configured to receive and direct cables, and the bumpers 5052 are configured to confront the array 5005 of the solar apparatus 5000. In the illustrated embodiment, the cable management frame 5044 includes two pairs of two hooks 5051. In other embodiments there are more than two pairs of two hooks (e.g., a third pair of hooks between the bumpers 5052, etc.) in accordance with organizational constraints. In other embodiments, there are less than two pairs of two hooks (e.g., one pair of two hooks on one side of the cable management frame 5044, etc.) in accordance with organization constraints. The cable management frame 5044 increases organization and secures placement of cables while also enabling the sliding of the first enclosure 5040 and the second enclosure 5042.

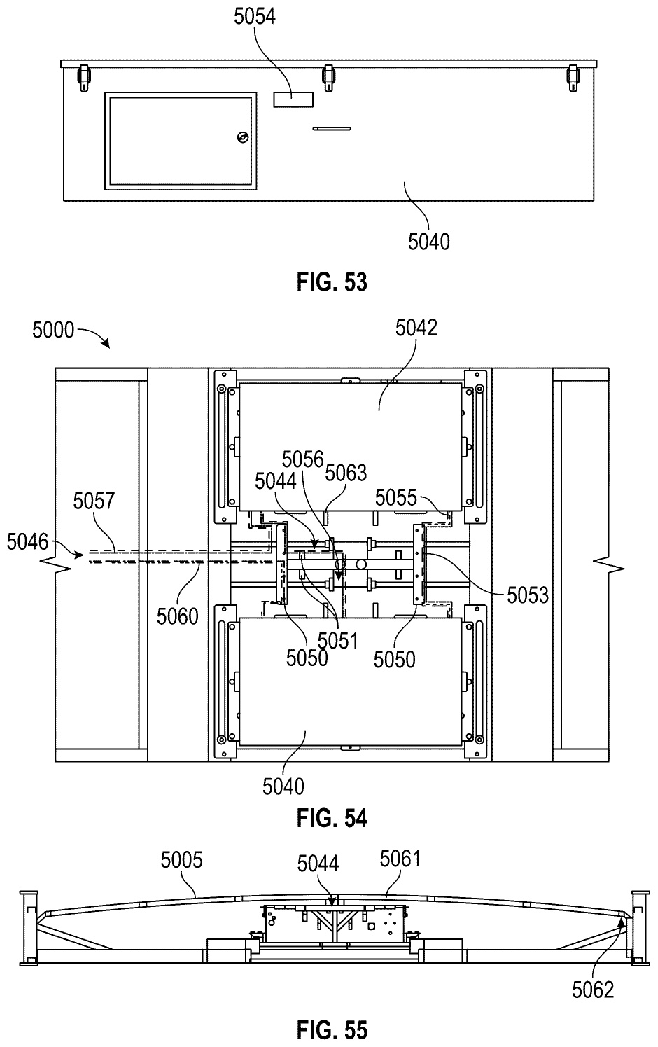

Referring now to FIG. 53, a front view of the first enclosure 5040. The first enclosure 5040 includes a fuel gauge 5054. Information from the fuel gauge 5054 is used before connecting multiple solar apparatuses 5000 together (e.g., to avoid differences in voltages while wiring connections, etc.). The fuel gauge 5054 may decrease installation and inspection time due to the easy access location of the fuel gauge 5054. In some embodiments, the second enclosure 5042 includes the fuel gauge 5054 or an additional fuel gauge 5054. In some embodiment, the QR code 5010 is located on the first enclosure 5040 or the second enclosure 5042.

Referring now to FIG. 54, a bottom view of a portion of the solar apparatus 5000 including the cable management frame 5044. The first enclosure 5040 and the second enclosure 5042 each also include a plurality of hooks 5063 configured to receive and direct the cables. As discussed previously, the cable management frame 5044 allows for secure and organized cable routing. A first cable set 5053 (e.g., DC jumper set, a battery cable set, etc.) and a second cable 5055 (e.g., 19-pin jumper, etc.) extend from the second enclosure 5042, along the lateral portion 5050 of the cable management frame 5044, and to the first enclosure 5040. A third cable set 5057 (e.g., a DC jumper AUX array, etc.) extends from the second enclosure 5042, along the lateral portion 5050 of the cable management frame 5044, and away from the second enclosure 5042 and the first enclosure 5040. A fourth cable set 5056 (e.g., a DC jumper primary array, etc.) extends from the second enclosure 5042, along the lateral portion 5050 of the cable management frame 5044, along the longitudinal portion 5049 and the hook 5051, and to the first enclosure 5040. A fifth cable set 5060 (e.g., a DC jumper set array, etc.) extends from the first enclosure 5040 along the lateral portion 5050 of the cable management frame 5044, and away from the first enclosure 5040 and the second enclosure 5042. The cable management frame 5044 may also form service loops from the first cable set 5053, the second cable 5055, the third cable set 5057, the fourth cable set 5056, and the fifth cable set 5060. The service loops may prevent cable drag, pinching, and stretching of the cables.

Referring now to FIG. 55, a cross-sectional view of a portion of the solar apparatus 5000, according to some embodiments. The solar apparatus 5000 includes a frame 5061. A plurality of loop clamps 5062 extend from the frame 5061. The loop clamps 5062 are configured to receive the cables to direct the cables from the first enclosure 5040 and the second enclosure 5042 towards the AC junction box 5008 and the DC junction box 5006.

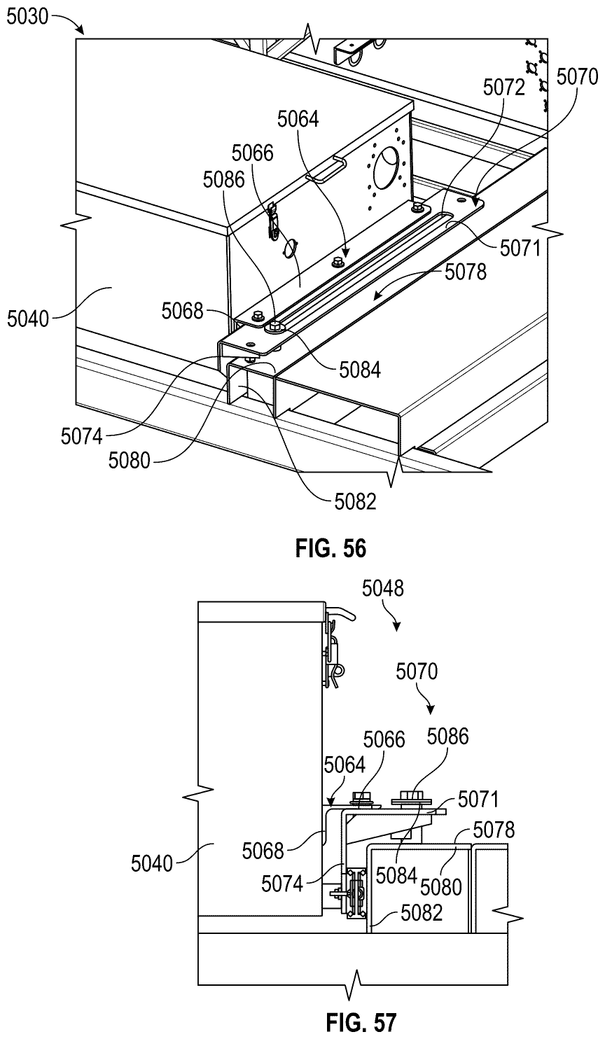

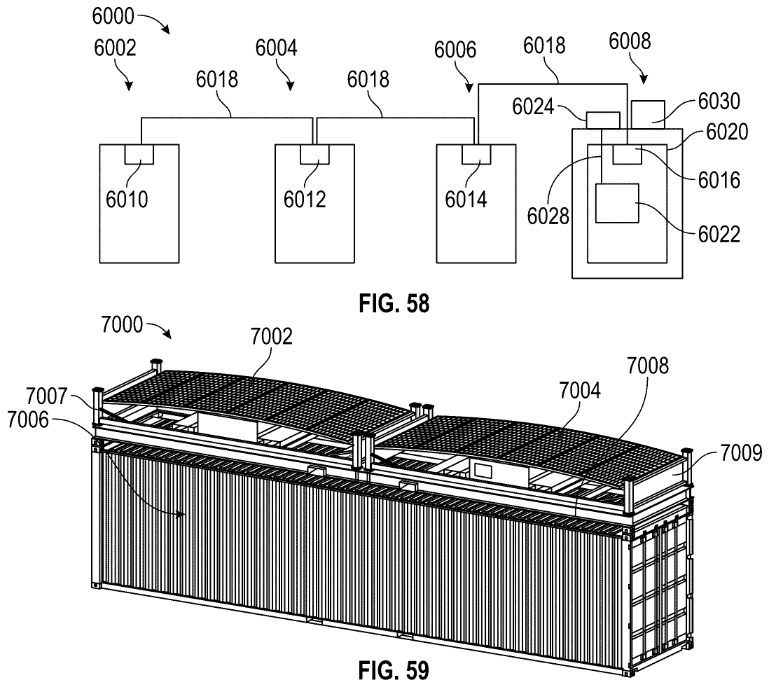

Referring now to FIGS. 56-57, a perspective, and a side view of one of the drawer mechanisms 5030. The drawer mechanisms 5030 includes a first bracket 5064, a second bracket 5070, and a third bracket 5078. The first bracket 5064 includes a lateral portion 5066 and a vertical portion 5068. The vertical portion 5068 couples to the first enclosure 5040 and is substantially parallel to a wall of the first enclosure 5040. The lateral portion 5066 of the first bracket 5064 extends from the vertical portion 5068 of the first bracket 5064. The second bracket 5070 includes a lateral portion 5071 and a vertical portion 5074. The vertical portion 5074 of the second bracket 5070 extends substantially parallel to the vertical portion 5068 of the first bracket 5064. The lateral portion 5071 of the second bracket 5070 is coupled to the lateral portion 5066 of the first bracket 5064.

The lateral portion 5071 of the second bracket 5070 defines a slot 5072. The slot 5072 receives a pin 5086. A washer 5084 couples between the pin 5086 and the lateral portion 5071 of the second bracket 5070. The pin 5086 is configured to act as a stop for the drawer mechanisms 5030 (e.g., the pin 5086 prevents the first enclosure 5040 from sliding farther than the length of the slot 5072 enables, prevent the first enclosure 5040 or the second enclosure 5042 from extending farther than a preset distance, etc.). The third bracket 5078 includes a lateral portion 5080 and a vertical portion 5082. The vertical portion 5082 of the third bracket 5078 is substantially parallel to the vertical portion 5074 of the second bracket 5070. The lateral portion 5080 of the third bracket 5078 is substantially parallel to and spaced from the lateral portion 5071 of the second bracket 5070. The pin 5086 extends between the lateral portion 5071 of the second bracket 5070 and the lateral portion 5080 of the third bracket 5078. The pin 5086 and slot 5072 prevent the first enclosure 5040 and the second enclosure 5042 from falling out of the solar apparatus 5000.

Referring now to FIG. 58, a block diagram of a solar assembly 6000. The solar assembly 6000 connects a plurality of solar apparatuses 5000 together. The solar assembly 6000 includes a first solar apparatus 6002, a second solar apparatus 6004, a third solar apparatus 6006, and a fourth solar apparatus 6008. The first solar apparatus 6002 includes a first solar junction box 6010, the second solar apparatus 6004 includes a second solar junction box 6012, the third solar apparatus 6006 includes a third solar junction box 6014, and the fourth solar apparatus 6008 includes a fourth solar junction box 6016. Solar cables 6018 couple the first solar junction box 6010 to the second solar junction box 6012, the second solar junction box 6012 to the third solar junction box 6014, and the third solar junction box 6014 to the fourth solar junction box 6016. The fourth solar apparatus 6008 includes a power distribution unit 6020, an active inverter 6022, an electric panel 6024, and an HVAC system 6030. The active inverter 6022 is electrically coupled to the electric panel 6024 by a cable 6028 (e.g., AC cable, etc.).

Power electronics of the solar apparatus 6004 allow for many embodiments of solar assemblies 6000. The power electronics permit combinations of the solar apparatuses 6004 in with other energy storage, grid energy, energy generation (e.g., generators, etc.), and various equipment powered by such electricity sources and storage. In some embodiments, the active inverter 6022 electrically couples to an ATS, and the ATS electrically couples to the electric panel 6024 and a grid. In some embodiments a generator couples to the fourth solar junction box 6016. In some embodiments, the cable 6028 couples to an ATS, the ATS couples to the electric panel 6024 and a grid, the electric panel 6024 couples to the fourth solar junction box 6016, and the fourth solar junction box 6016 couples to a generator. In some embodiments, the cable 6028 couples to the electric panel 6024 of each of the first solar apparatus 6002 and the second solar apparatus 6004, and the power distribution unit 6020 couples to the active inverter 6022 of the first solar apparatus 6002. In some embodiments, the cable 6028 couples to the electric panel 6024 of each of the first solar apparatus 6002, the second solar apparatus 6004, and the third solar apparatus 6006, and the power distribution unit 6020 couples to the active inverter 6022 of one of the first solar apparatus 6002, the second solar apparatus 6004, or the third solar apparatus 6006. In some embodiments, the power distribution unit 6020 couples to the electric panel 6024 on the first solar apparatus 6002 and the electric panel 6024 on the second solar apparatus 6004, the power distribution unit 6020 couples to an ATS, and the ATS couples to a grid and the active inverter 6022 of one of the first solar apparatus 6002 or the second solar apparatus 6004. In some embodiments, the power distribution unit 6020 couples to the electric panel 6024 of the first solar apparatus 6002, the power distribution unit 6020 couples to the electric panel 6024 of the second solar apparatus 6004, the power distribution unit 6020 couples to the active inverter 6022 of the first solar apparatus 6002, the electric panel 6024 of the first solar apparatus 6002 couples to the solar junction box of the first solar apparatus 6002, and the solar junction box couples to a generator. In some embodiments, a generator couples to a plurality of junction boxes (e.g., first solar junction box 6010 and second solar junction box 6012, third solar junction box 6014 and fourth solar junction box 6016, etc.). Various such combinations of components are contemplated by the present disclosure to provide micro-grids in accordance with the teachings herein.

Referring now to FIG. 59, a solar assembly 7000, according to some embodiments. The solar assembly 7000 includes a first array 7002 and a first frame 7007 (e.g., to form a first solar apparatus, etc.), a second array 7004 and a second frame 7009 (e.g., to form a second solar apparatus, etc.), and a cradle 7008. The first array 7002 couples to the first frame 7007 and the second array 7004 couples to the second frame 7009. The first frame 7007 and the second frame 7009 couple to the cradle 7008. The cradle 7008 couples to the mobile building 7006.

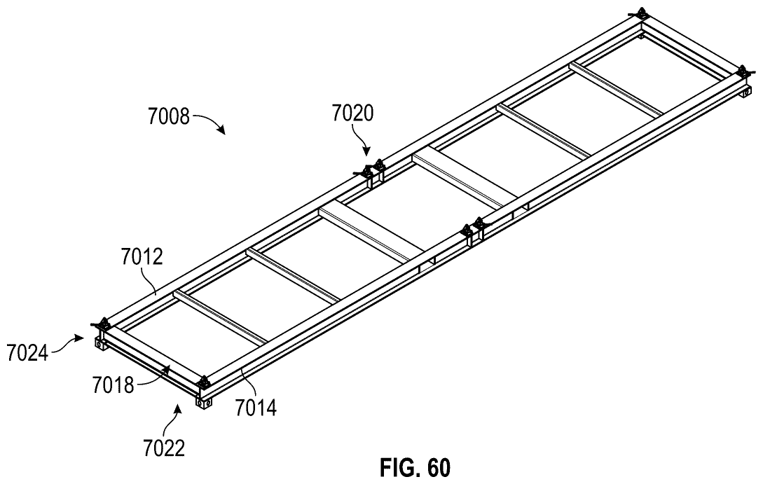

Referring now to FIG. 60, the cradle 7008, according to some embodiments. The cradle 7008 includes a first longitudinal side 7012, a second longitudinal side 7014, a plurality of rungs 7018 (e.g., lateral portions, etc.), and a plurality of locks 7020 (e.g., twist locks, etc.). The first longitudinal side 7012 extends substantially parallel to the second longitudinal side 7014. The rungs 7018 extend substantially perpendicular to the first longitudinal side 7012 and the second longitudinal side 7014. The locks 7020 extend from the first longitudinal side 7012 and the second longitudinal side 7014 and are configured to couple to one of the frames 7007, 7009 and the mobile building 7006. The cradle 7008 also defines a plurality of fork pockets 7022 and includes a plurality of rigging points 7024. The fork pockets 7022 and the rigging points 7024 are configured to assist an operator in lifting and positioning the solar apparatus 7000.

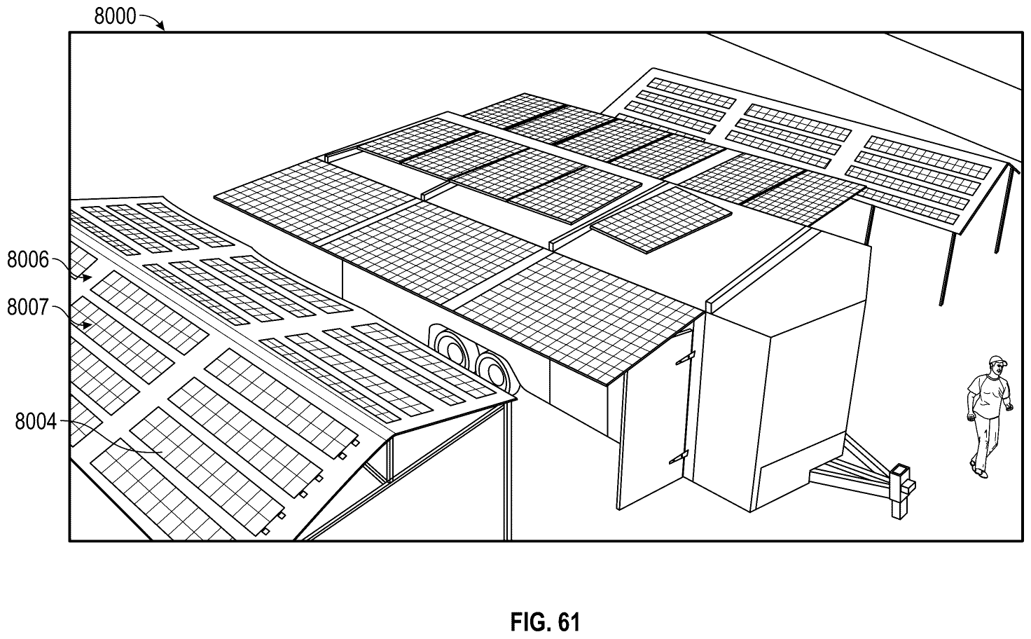

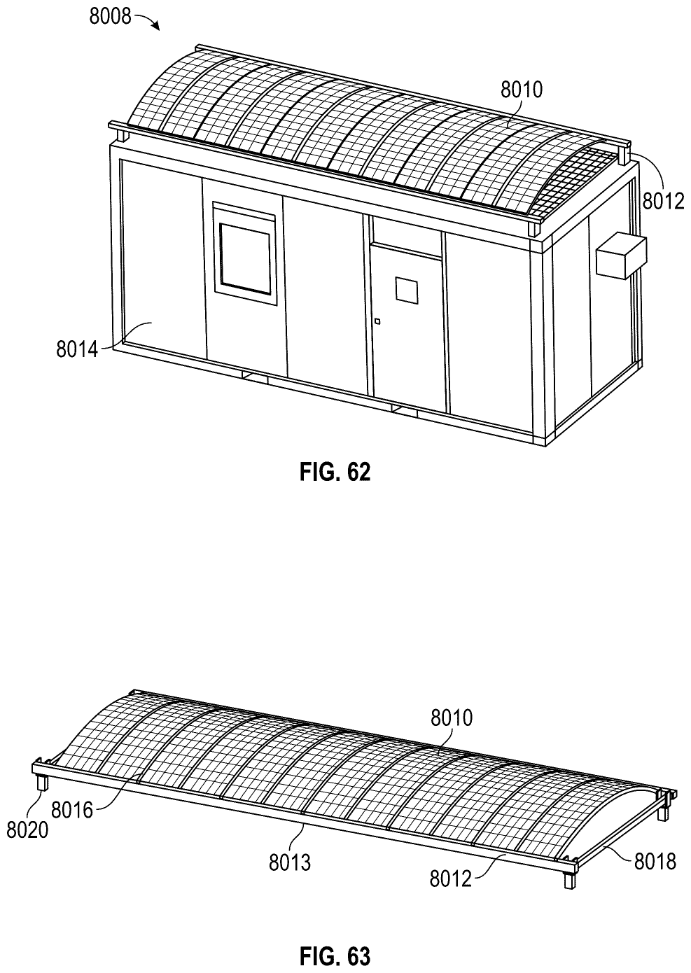

Referring now to FIG. 61, a solar apparatus 8000, according to some embodiments. The solar apparatus 8000 is configured as substantially the same as the solar apparatus 7000 described above. However, the solar apparatus 8000 includes a canopy 8004 (e.g., lily pad, flexible array, etc.) instead of an array 7002, 7004. The canopy 8004 includes a plurality of solar panels 8006 coupled to a fabric 8007 (e.g., tarp, etc.). In some embodiments, the canopy 8004 is coupled to a frame, and the frame is coupled to a structure (as in FIGS. 62-65). In some embodiments, the canopy 8004 is coupled directly to a structure with or without the frame.

Referring now to FIGS. 62-63, perspective views of a solar apparatus 8008 are shown, according to some embodiments. FIG. 62 shows the solar apparatus 8008 deployed on a mobile structure 8014, with FIG. 63 showing the solar apparatus 8008 without the mobile structure 8014. The solar apparatus 8008 includes a canopy 8010 and a frame 8012. The frame 8012 includes a plurality of longitudinal members 8013, a plurality of braces 8016 (e.g., curved portions, framing members, etc.), a plurality of lateral members 8018, a plurality of vertical members 8020. The longitudinal members 8013 are substantially parallel to each other and substantially perpendicular to the plurality of lateral members 8018. The longitudinal members 8013 and the plurality of lateral members 8018 form a rectangular base. Each plurality of vertical members 8020 extends from a corner of the frame 8012 towards the mobile structure 8014. The plurality of vertical members 8020 are configured to be received by the mobile structure 8014. The braces 8016 extend between the longitudinal members 8013 and are curved. The canopy 8010 couples to the braces 8016.

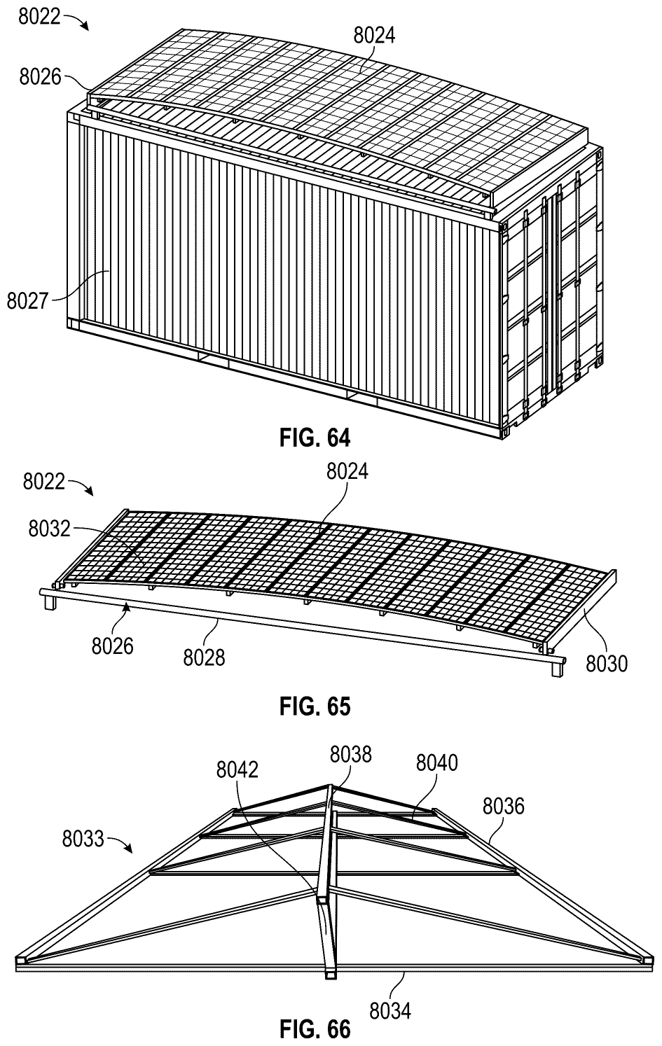

Referring now to FIGS. 64-65, perspective views of a solar apparatus 8022 are shown, according to some embodiments. FIG. 64 shows the solar apparatus 8022 deployed on a mobile structure 8027, with FIG. 65 showing the solar apparatus 8022 without the mobile structure 8027. The solar apparatus 8022 is substantially similar to the solar apparatus 8008. However, a frame 8026 of the solar apparatus 8022 includes a plurality of longitudinal members 8028 that are configured to be closer to the mobile structure 8027 than a plurality of lateral members 8030 of the frame 8026 (e.g., the lateral members 8030 are coupled on the longitudinal members 8028 instead of between the longitudinal members 8028). Braces 8032 of the frame 8026 are substantially less curved than the braces 8016 of the previous embodiment, and therefore a canopy 8024 of the solar apparatus 8022 is substantially flatter than the canopy 8010 of the previous embodiment. In some embodiments, the braces 8032, and therefore the canopy 8024 are substantially parallel to a roof of the mobile structure 8027 (e.g., substantially parallel to the plurality of lateral members 8030, the canopy 8024 is flat, etc.).

Referring now to FIG. 66, a perspective view of a frame 8033 configured to receive a canopy. The frame 8033 includes a plurality of lateral members 8034, a plurality of outer longitudinal members 8036, a plurality of inner longitudinal members 8038, a plurality of braces 8040, and a plurality of vertical members 8042. The plurality of outer longitudinal members 8036 and the plurality of lateral members 8034 form a rectangular section configured to couple to a roof of a mobile structure. The plurality of vertical members 8042 extend from a center of the plurality of lateral members 8034. The plurality of outer longitudinal members 8036 and the plurality of inner longitudinal members 8038 are substantially parallel to one another, and the plurality of inner longitudinal members 8038 extend substantially perpendicular to the plurality of vertical members 8042. The plurality of braces 8040 extend between the plurality of inner longitudinal members 8038 and the plurality of outer longitudinal members 8036.

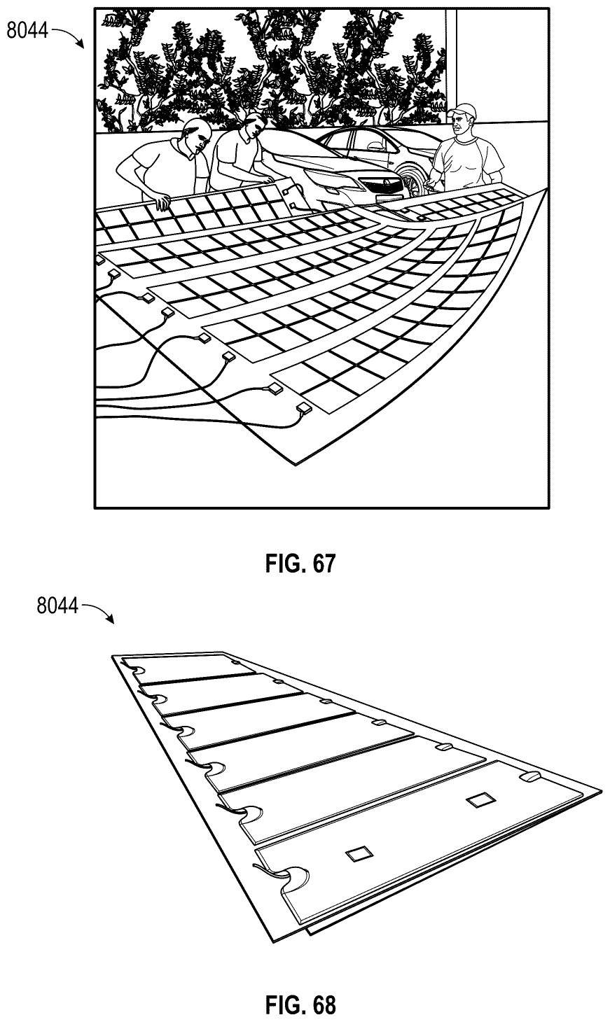

Referring now to FIGS. 67-68, perspective views of a canopy 8044. FIG. 67 shows the canopy 8044 being unfolded and FIG. 68 shows the canopy 8044 folded. The flexible and foldable nature of the canopy 8044 may provide solar energy collection that is cheaper and lighter than a conventional solar panel. The canopy 8044 may be easier to install and remove than conventional solar panels.

### Configuration of Embodiments

When the terms “approximately,” “about,” “substantially,” and similar terms are used herein as applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the solar apparatuses as shown in the various exemplary embodiments is illustrative only. Additionally, any element disclosed in one embodiment may be incorporated or utilized with any other embodiment disclosed herein. For example, the mounting features, leg assembly, etc. shown in FIGS. 17-20 with single-array solar apparatuses may also be used with multi-array solar apparatuses (e.g., as in FIG. 1). Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A solar apparatus for use with a mobile building, the solar apparatus comprising:
an enclosure; and
an array of photovoltaic panels, wherein a convexity of the array along a longitudinal direction of the solar apparatus defines an open space under the array, wherein the enclosure is positioned in the open space.

2. The solar apparatus of claim 1, further comprising a base frame member extending along the longitudinal direction of the solar apparatus, wherein:
the base frame member is substantially straight; and
the open space is between the base frame member and the array of photovoltaic panels.

3. The solar apparatus of claim 2, wherein the convexity of the array is such that longitudinal ends of the panel are closer to the base frame member than a longitudinal center of the panel.

4. The solar apparatus of claim 3, wherein the enclosure is positioned at the longitudinal center of the panel.

5. The solar apparatus of claim 2, wherein:
the base frame member comprises a first beam and a second beam, each defining a channel and spaced for receiving forks of a standardized forklift; and
the enclosure includes one or more inlet plugs to provide power to the solar apparatus and one or more outlet plugs to enable access to power generated by and/or stored by the solar apparatus.

6. The solar apparatus of claim 2, further comprising:
a lateral base frame member extending along a lateral direction of the solar apparatus;
a first junction box extending along the lateral base frame member;
a second junction box extending along the lateral base frame member; and
a second enclosure positioned in the open space.

7. The solar apparatus of claim 2, wherein the array is coupled to a flexible fabric.

8. The solar apparatus of claim 2, further comprising a cable management frame comprising:
a vertical portion;
a longitudinal portion extending along the longitudinal direction of the solar apparatus, the longitudinal portion centered on the vertical portion;
a plurality of hooks extending from the longitudinal portion; and
a plurality of bumpers extending from the longitudinal portion.

9. The solar apparatus of claim 1, wherein the enclosure is configured to slide from a stowed position in the open space under the array to an access position laterally extending from the array.

10. The solar apparatus of claim 1, further comprising:
battery energy storage components positioned in the enclosure; and
control components and electronics configured to manage energy from the photovoltaic panels or other energy source and to manage charging and discharging of the battery energy storage components.

11. The solar apparatus of claim 1, wherein the array comprises a flexible PV panels coupled to a flexible backing sheet to form a panel assembly.

12. The solar apparatus of claim 11, further comprising a curved frame comprising a beam, the beam comprising a groove, an edge of the panel assembly received in the groove.

13. The solar apparatus of claim 1, further comprising an additional array moveable relative to the array, the additional array having a curvature substantially matching the convexity of the array.

14. The solar apparatus of claim 13, further comprising a cable management system configured to maintain, throughout a range of motion of the additional array, a constant distance for a path of travel for a cable extending between the additional array and the enclosure.

15. The solar apparatus of claim 14, wherein the cable management system comprises a first arm coupled in series with a second arm, wherein the first arm has a first end at a fixed point on a frame of the panel and the second arm has a second end at a fixed point on the additional array.

16. The solar apparatus of claim 15, wherein the cable management system further comprises a track and a trolley slidable along the track, wherein a joint between the first arm and the second arm is at the trolley.

17. The solar apparatus of claim 1, further comprising:
corner posts;
a clamp configured to laterally span a roof of the mobile building;
connectors coupling the corner posts to the clamp; and
support legs coupled to the clamp and extending along a height of the mobile building.

18. The solar apparatus of claim 1, further comprising corner posts, wherein a height of the corner posts is greater than a height of the array and the corner posts facilitate stacking of the solar apparatus on or under an additional solar apparatus.

19. A solar assembly for use with a mobile building comprising:
a first solar apparatus comprising:
a first enclosure;
a first array of photovoltaic panels, wherein a convexity of the first array along a longitudinal direction of the first solar apparatus defines an open space under the first array, wherein the first enclosure is positioned in the open space; and
a first base frame member extending along the longitudinal direction of the first solar apparatus;
a second solar apparatus comprising:
a second enclosure;
a second array of photovoltaic panels; and
a second base frame member; and
a cradle extending along the longitudinal direction of the first solar apparatus, the cradle configured to receive the first base frame member and the second base frame member and couple to the mobile building.

20. A solar assembly comprising:
a first solar apparatus for use with a first mobile building comprising:
an enclosure; and
an array of photovoltaic panels, wherein a convexity of the array along a longitudinal direction of the first solar apparatus defines an open space under the array, wherein the enclosure is positioned in the open space; and
a second solar apparatus for use with a second mobile building;
wherein the first solar apparatus is configured to electrically couple to the second solar apparatus.
